(19) United States
(12) Patent Application Publication
(10) Pub. No.: US 2024/0042632 A1
(43) Pub. Date: Feb. 8, 2024

(54) Advanced Battery Systems and Related Sensor Integration and Data Acquisition Apparatus, Method, and System

(71) Applicant: Forward Entertainment & Technology, LLC, Washington, DC (US)

(72) Inventors: James Lowell Ramsey Clarke, Washington, DC (US); William Lloyd Huston, Palo Alto, CA (US); David Kyle Miller, Washington, DC (US); John Ramsey Clarke, Washington, DC (US)

(73) Assignee: Forward Entertainment & Technology, LLC, Washington, DC (US)

(21) Appl. No.: 18/368,566

(22) Filed: Sep. 14, 2023

Related U.S. Application Data
(63) Continuation of application No. 16/443,878, filed on Jun. 18, 2019.
Application No. 16/443,878 is a division of application No. 16/443,878, filed on Jun. 18, 2019.
Application No. 16/443,878 is a continuation-in-part of application No. 15/903,042, filed on Feb. 23, 2018, now abandoned.
Application No. 15/903,042 is a continuation-in-part of application No. 15/951,172, filed on Apr. 12, 2018, now Pat. No. 11,793,301.
Application No. 15/951,172 is a continuation-in-part of application No. 15/951,172, filed on Apr. 12, 2018, now Pat. No. 11,793,301.
(60) Provisional application No. 62/462,861, filed on Feb. 23, 2017.
(60) Provisional application No. 62/687,248, filed on Jun. 20, 2018.
(60) Provisional application No. 62/484,870, filed on Apr. 12, 2017.

(51) Int. Cl. B26B 19/38; B60L 53/12; A43B 3/34; A46B 15/00; A61C 17/22; H02J 7/00; H02N 15/00

(52) U.S. Cl. CPC B26B 19/388; B60L 53/12; A43B 3/34; A46B 15/0026; A61C 17/224; H02J 7/00; H02J 7/0042; H02N 15/00; A43B 7/00

(57) ABSTRACT

The disclosures herein relate to the design of one or more battery monitoring or maintenance devices in some embodiments including guidance for autonomous vehicles for recharging, service or replacement of batteries or related devices. These devices may include but are not limited to devices that monitor and/or maintain the health of batteries or related devices that monitor and/or maintain the health of assets. The devices include batteries for vehicles, oral cleaning devices, smart-clothing with integrated batteries and sensors and charging pads which may monitor the health or assets being charged. Sensors may be integrated in these devices including but not limited to IMUs, thermocouples or oral cleaning devices, IMUs in clothing like shoes or wrist bands, or timers or charging sensors in magnetic surfaces which may cause one or more objects and/or other magnetic surfaces to float when a desired function is achieved.

### CROSS-REFERENCE TO RELATED APPLICATIONS

The present application is a continuation/divisional application that claims priority to U.S. Non-Provisional patent application Ser. No. 16/443,878, filed Jun. 18, 2019 which claims priority to U.S. Provisional Patent Application No. 62/687,248, filed Jun. 20, 2018. The present application is also a continuation-in-part that claims priority-in-part to U.S. Non-Provisional patent application Ser. No. 15/903,042, filed Feb. 23, 2018, which claims priority to U.S. Provisional Patent Application No. 62/462,861 filed Feb. 23, 2017. The present application is also a continuation-in-part that claims priority-in-part to U.S. Non-Provisional patent application Ser. No. 15/951,172, filed Apr. 12, 2018, which claims priority to U.S. Provisional Patent Application No. 62/484,870 filed Apr. 12, 2017. The entire disclosure of U.S. Non-Provisional patent application Ser. Nos. 16/443,878, 15/903,042 and 15/951,172 and U.S. Provisional Patent Applications Nos. 62/687,248, 62/462,861 and 62/484,870 are incorporated herein by reference.

### TECHNICAL FIELD

The general field of the disclosure herein relates to maintenance related apparatuses, methods and systems comprising one or more battery devices and/or charging systems to be used in tandem with one or more powered assets including but not limited to vehicles, health devices or related sensors. This disclosure includes but is not limited to devices that monitor and/or maintain the health of batteries or charging systems or devices that monitor and/or maintain the health of the powered assets. The disclosure further includes systems for maintaining, recharging and monitoring batteries and extend to batteries integrated within clothing for monitoring the health and fitness of users and charging pads which may monitor the health or assets being charged. Sensors may be integrated in these devices including but not limited to IMUs, thermocouples or oral cleaning devices, IMUs in clothing like shoes or wrist bands, or timers or charging sensors in magnetic surfaces which may cause one or more objects and/or other magnetic surfaces to float when a desired function is achieved. This disclosure further comprises the design of the batteries and charging systems, oral cleaning devices, sensor data integration system, or the powered or levitation response system. The disclosure further describes sensors including but not limited to Inertial Measurement Unit (IMU) sensor, a powered or levitation system may respond to a mechanism, including but not limited to a timer, a proximity sensor or an electrical impulse. In some embodiments of the present disclosure the data gleamed from the sensors is integrated into an Artificial Intelligence, Machine Learning, or Deep Learning system which better informs the user or a controlling AI of their decision-making process with regard to their battery health, their use of the device the sensors are integrated into or the health of the asset being monitored. In some such embodiments the data monitored may be seamlessly shared with professionals at the user's discretion, including but not limited to one or more doctors, dentists, or reliability engineers who are using an integrated application. In other embodiments this data may be shared between other devices and systems including but not limited to automated facilities or servicing the equipment described in this disclosure. In yet other embodiments sensors may be integrated into a device that exploits physical principles to create an electromagnetic field. In some other embodiments, a magnetic field is created to activate and/or regulate the force exerted between the device, and ultimately one or more objects that is on top off or adjacent to it. Other embodiments involve directly applied mechanical means to dampen the force applied, including but not limited to springs, elastomers, or one or more motors that adjust the force applied in response to a sensor that detects one or more criteria, including but not limited to time, location, or the weight or type of object or device that is placed on top of it. In some embodiments the disclosed device may be a magnetic charging pad that causes an object, including but not limited to an electric toothbrush, a cell-phone, or an electric razor to levitate the moment said object achieves a certain charge. In some such embodiments the utility of such levitation may be for display purposes. In other such embodiments the utility of such powered response may be to prevent the object from overcharging. In other such embodiments the device may be an electromagnet that causes another object to float the moment the electromagnet itself is fully charged. In certain embodiments, such a device may have motors that cause the magnet and the floated device to rotate in tandem, lights moving in tandem or some combination.

### BACKGROUND

The disclosures herein relate to a system of interchangeable batteries for one or more devices including but not limited to electric vehicles, toothbrushes or cell phones, and may additionally comprise sensors and data systems incorporating Artificial Intelligence (AI), Machine Learning (ML) or Deep Learning (DL) to enhance preventive maintenance techniques for the health of one or more users or on or more of a user's assets, including but not limited to a battery or vehicle life. The history of modern batteries may be traced to the mid-18^{th} century when Leyden jars were used to store electrical charges as an early type of capacitor. US Founding Father, Benjamin Franklin is known to have called his group of jars an “electrical battery” as a salute to the military description of a group of weapons that function in unison. Experimentation with Lithium batteries may have begun in 1912 under the study of American chemist Gilbert Lewis, but Lithium-ion batteries were not commercialized until the 1970s. Now lithium-ion batteries are used in any number of devices including but not limited to rechargeable cell phones, laptops, electric vehicles, and radio-controlled aircraft. In the field of electrical vehicles in particular there exists room for improvement in how these batteries are utilized with complaints of there not being enough charging stations, charging taking too long and it being inconvenient to leave one's car somewhere for hours at a time when refueling with gas only took seconds to minutes. One of the chief complaints of electric vehicle naysayers is that such vehicles take too long to charge and can only hold enough charge to travel a few hundred miles before they have to recharge for hours. By implementing a system of interchangeable batteries and facilities for removing batteries from one vehicle and replacing it with a removed and recharged battery taken from another, the system of gas stations utilized for refueling can be replaced in the electric vehicle (EV) era with a system of battery stations where new batteries are delivered, and serviceable replacement batteries are returned and recharged so traveling EVs can replace their batteries and keep moving, for a fee. A system where batteries are swapped, vehicles are directed to and returned from a charging or servicing station or a recharging or servicing drone is sent to the vehicle could be a monumental improvement to the current system. Furthermore, battery related devices where different methods of alerting users of a full charge being reached, in some cases utilizing magnetism and levitation, could be useful, particularly with smaller devices. Legends regarding the discovery of magnetic properties by humanity contend that some 4,000 years ago a shepherd named Magnes in a region of Greece called Magnesia was walking when his metal tipped staff and the nails holding his shoes together became stuck to a black rock he was walking over. He found loadstones containing Fe3O4 which the Greeks labeled magnetite after the man, the region, or both. Early philosophers such as Pliny the Elder theorized magnetic stones contained magical powers and magnetite became shrouded in superstition. Chinese scholars developed a mariner's compass utilizing a loadstone splinter, carefully floated on the surface tension of water. Over time the magnetic attraction of Earth, the protection of the Magnetic sphere around similar celestial bodies and the ties between electricity and magnetism would all become discovered and magnets became utilized for attraction and repulsion, the function of computers, medical scanners and all sorts of electronics. (Jezek, Geno, “How Magnets Work”, 2006, http://www.howmagnetswork.com/history.html, Read Apr. 26, 2018).

Magnetic Levitation has been used for a variety of purposes, including but not limited to floating trains so that they may move at high speeds in a relatively frictionless environments such as Japan's Shinkansen train line, for the purpose of propulsion such as in launching spacecraft or rail-gun systems, or to reduce the friction between parts or components such as a magnetic coupling between a pump and motor causing a motor to churn a pump without significant wear and tear on the shaft, coupling or associated components (Sarah Fecht, “8 Ways Magnetic Levitation Could Shape the Future”, Popular Mechanics, Mar. 21, 2012).

One of the less discussed features of magnetic levitation seems to be its use for display purposes or conserving battery life. While permanent and electromagnets have been used to float objects in demonstration, the applicant are not aware of any such magnetic levitation devices which cause objects to raise without the direct input of the user. This presents opportunity for investment and exploration into some of the potential means of carrying out electromagnetic levitation without the direct input of the user and into some of the potential uses for electromagnetic levitation. Magnetism that trains users based on the burgeoning field of AI could have health benefits particularly in training users to brush properly or move better. Utilizing AI, ML, or DL in conjunction with sensors to detect how well a user is moving, brushing, or managing their health is a relatively new concept, but advances in the field of clothing, health and dentistry go back thousands of years to the cradle of civilization.

Before toothbrushes, people used rough cloth and water to clean their teeth. They would also rub things like salt and chalk across their teeth to try to get rid of the grime. As long ago as 3000 BC, the ancient Egyptians constructed crude toothbrushes from twigs and leaves to clean their teeth. These sticks were rubbed against the teeth. The bristle toothbrush, similar to the type used today, was not invented until 1498 in China. The bristles were actually the stiff, coarse hairs taken from the back of a hog's neck and attached to handles made of bone or bamboo. The first documented toothbrush that closely resembles the ones typically used today was made in England in the 1770s. Records show that a man named William Addis came up with the idea while he was in prison, put there for having started a riot. He didn't think the rag he was given was cleaning his teeth well enough, so he saved a small bone from a meal. He put tiny holes in it and used glue to attach pig bristles he had gotten from a prison guard. The first patent for a toothbrush was awarded to an American named H. N. Wadsworth in 1857, but it wasn't until the invention of nylon in the 1930s that toothbrushes came to look like the ones you use. It wasn't until after World War II that Americans started brushing their teeth regularly. (Strauss, Valerie, Washington Post, “Ever Wondered How People Cleaned Their Teeth Before They Had Toothbrushes?”, Apr. 13, 2009 http://www.washingtonpost.com/wp -dyn/content/article/2009/04/12/AR2009041202655.html Read Mar. 27, 2017)).

Since the 1930s, the tools and methods for cleaning one's teeth have remained relatively unchanged, while our knowledge of the importance of good oral hygiene has improved dramatically. While common practices such as brushing and flossing twice a day have been widely disseminated, a staggering number of elderly Americans suffer from diseases related to poor oral hygiene and many even require dentures later in their lives. Despite the advances in chronic, or acute, dental treatment, much more has to be done to address preventative measures, specifically how to improve oral hygiene leveraging tools and procedures that are used on a daily basis.

Recent forays into dental hygiene patents include vibration dampening toothbrushes (Cacka, Joe W., Chiles, Howell H., 2005, Toothbrush, Water Pik, Inc. (CO, US) U.S. Pat. No. 6,920,659; WO/2002/054906; 20020120991), toothbrushes with interchangeable parts (Jimenez, Eduardo J. et al., 2010, Toothbrush, Colgate-Palmolive Company (NY, US), EP2258307), manual toothbrushes designed to assist in evenly distributing the amount of force applied (Rauch, Samuel (NY, US), 1984, Toothbrush, U.S. Pat. No. 4,472,853), toothbrushes designed to be appealing for use by children ergonomically (Jimenez, Eduardo J. et al., 2010, Toothbrush Colgate-Palmolive Company (NY, US), 20070050931), toothbrushes with flexible elements (Brown Jr., William R. et al., 2016, Oral hygiene implements having flexible elements, and methods of making the same, The Gillette Company (MA, US), U.S. Pat. No. 9,504,312), toothbrushes (manual or motorized) with indicator mechanisms that are notable by the user during use (Jungnickel, Uwe, Altmann, Niclas, 2016, Oral hygiene implement, Braun GmbH (Kronberg, DE), U.S. Pat. No. 9,439,740), and a force sensing oral care instrument that provides feedback to the user for self-adjustment (Jungnickel, Uwe, Altmann, Niclas, Guebler, René, 2014, Force sensing oral care instrument, Braun GmbH (Kronberg, DE), U.S. Pat. No. 8,832,895).

None of these devices however deal with the automated regulation of pressure applied in cleaning of one's oral components, including but not limited to the teeth, gums, or tongue. A device, method or system tying together battery health, user health and/or equipment health will have a major impact on the quality of life, health of users and the environment of the modern era.

### SUMMARY OF THE INVENTION

This disclosure comprises an apparatus, method and system for one or more rechargeable batteries or battery replacement mechanisms or facilities which interact autonomously or semi-autonomously to ensure seamless continuous usage of any number of devices including but not limited to toothbrushes, cellphones or electrical vehicles. In the case of electric vehicles such an improvement would allow electric vehicles to operate seamlessly without the need for the vehicle to sit idly charging. In the case of cell phones or toothbrushes such improvements may allow for extended usage of these devices with reminders, shipping or automated replacement of said batteries before deterioration effects the useful life of the device. In some embodiments these magnetic surfaces which may cause one or more objects and/or other magnetic surfaces to float when a desired function is achieved. A novel aspect of this invention is the response system. In some embodiments it may respond to a mechanism, including but not limited to a timer, a proximity sensor or an electrical impulse. In some embodiments of the present disclosure the invention exploits physical principles to create an electromagnetic field. In such embodiments, a magnetic field is created to activate and/or regulate the force exerted between the device, and ultimately one or more objects that is on top off or adjacent to it. Other embodiments may involve directly applied mechanical means to dampen the force applied, including but not limited to springs, elastomers, or one or more motors that adjust the force applied in response to a sensor that detects one or more criteria, including but not limited to time, location, or the weight or type of object or device that is placed on top of it. In some embodiments the disclosed device may be a magnetic charging pad that causes an object, including but not limited to an electric toothbrush, a cell-phone, or an electric razor to levitate the moment said object achieves a certain charge. In some embodiments the utility of such levitation may be for display purposes. In other embodiments the utility of such levitation may be to prevent the object from overcharging. In other embodiments the device may be an electromagnet that causes another object to float the moment the electromagnet itself is fully charged. In certain embodiments, such a device may have motors that cause the magnet and the floated device to rotate in tandem, lights moving in tandem or some combination.

The components of some such embodiments of the device comprise a magnetic pad and an object comprising a wholly or partially magnetic surface. In some such embodiments one or more of these components may be an electro magnet, and a magnetic field will exist between these two components when one or both of these components comprising an electromagnet is active. Another component to some such embodiments of the present disclosure is a detection component which generates a response to activate the electromagnetic surface. In some such embodiments this detection component may be activated by means including but not limited to the magnetic pad also being a charging pad and the object being charged by the pad to a level that is preset to trigger the activation of the electromagnet on the magnetic pad, a timer that triggers the activation or deactivation of the magnetic pad or the object, or some combination therein. A current source and current regulating mechanism are required to generate and adjust magnetic flux in certain such embodiments. The magnetic field intensity is a function of that flux and material properties of the device. In some such embodiments the intensity of the magnetic field can be adjusted by means including but not limited to a dial located on the magnetic pad by changing the current in the circuit, which will select the power of the electromagnet, controlling the height at which the object is floated to, a switch to accomplish the same in increments, or a sensor that acts in response to the object being charged.

Some of the benefits of these means and uses include but are not limited to the timer that causes an electro-magnet to activate and float an object, the electro-magnet which activates when charged to a manufacturer defined, and machine learning adjusted or user defined set point—may have the added benefit of preserving battery life of a rechargeable battery and avoids overcharging, or a motor or system of motors powering the rotation of an electromagnet that causes the electromagnet to spin once the electromagnet is charged sufficiently for the purpose of displaying a floated object to a user from multiple angles. These practical improvements could also provide the benefit of making a more attractive display for users than what is currently available. In some such embodiments a toothbrush with springs or magnetic dampers utilized to reduce force on the gumline may be the object that works in tandem with the disclosed device such that the magnetic field of the device guides the brush to clean the user's mouth. In certain embodiments the object may be charged by being tethered to the pad but trigger the pad's electromagnet to activate once a certain charge is reached. In other embodiments once a device is placed on the magnetic pad or tethered to it for a certain amount of time, the electromagnet in either the object, the pad or both may be activated to trigger the repulsion of the two devices. In yet other embodiments the object may rest on a magnetic holder which is repulsed from the magnetic pad once a certain response is achieved, including but not limited to the object resting in the holder for a certain amount of time, the object charging to a certain percentage, machine learning determining the type of object place on the holder, or human input. Other embodiments of the present disclosure may involve rotating floated objects such as a cellphone which raises and rotates continuously 360 degrees when charged, including components such motors and gears to facilitate the turning of the magnetic pad which causes the repulsed object to rotate in tandem. Any of the above-described embodiments may be varied in additional embodiments include charging mechanisms including but not limited to components for plugging them in, solar energy collection, rechargeable batteries that may be utilized with charging pads, replaceable batteries, or wireless charging mechanisms.

Another embodiment of the disclosure is an apparatus and system for a magnetized oral hygiene device to be used regularly in order to standardize, optimize and monitor the efficacy of methods to improve oral hygiene, while minimizing the damage due to abrasion to improve oral health. This disclosure further sets forth embodiments of the invention sufficiently for someone of ordinary skill in the art to comprehend, to illustrate and describe the various embodiments and their components, including but not limited to an oral hygiene instrument holder with force dampening and/or force applying technology, a motorized semi-autonomous tooth scrolling oral cleaner, or a stationary, form-fitting oral cleansing device, and to provide related variations of a design that accomplishes the feat of decoupling forces imparted onto the cleaning device by the user from the forces that are transferred to the brush which contact the mouth during cleanings through various means of dampening including but not limited mechanical methods either compressible fluids, materials, springs, or use of magnetic fields, or additional autonomous methods for cleaning oral cavities without requiring any force to be imparted by the user, or any combination of the aforementioned.

Some components of such embodiments of the device comprise the holder and the oral hygiene device; a magnetic field will exist between these two components. A current source and current regulating mechanism are required to generate and adjust magnetic flux in certain such embodiments. The magnetic field intensity is a function of that flux and material properties of the device. In some such embodiments the intensity of the magnetic field can be adjusted by means including but not limited to a dial located on the holder by changing the current in the circuit, which will select the pressure that can be exerted on a tooth for example, within an oral cavity, a switch to accomplish the same in increments, or a sensor that acts in response to the shape of the gum-line.

In certain embodiments during instances when the user applies a given force via the holder, that force cannot be imparted in the mouth until the magnetic field between the holder and the brush is overcome. In some such embodiments, the point at which the magnetic field is overcome is marked by contact between the brush and the holder. In some such embodiments, the brush and the holder will not be in contact when the user implies less force than required to overcome the selected force of the given magnetic field. In some such embodiments the strength of the magnetic field will determine how much force is imparted by the user into the mouth. In some such embodiments contact will initiate a gentle corrective vibration and/or a mild lighting indicator until the user reduces the force applied on the holder and as a result in the mouth and the two components lose contact. In other embodiments, a control system will exist that counteracts the force of the user. In some such embodiments, when a user applies a given force to the holder, the magnetic field will provide a force equal and opposite of the direction provided by the user, less the force necessary to generate the minimal amount of friction required to clean teeth. The counter-balancing effect ability of the control system allows the user a regular an unmodified force without ever exceeding the desired magnitude of force desired. In other such embodiments instead of the force applied by the magnetic field being less than or equal to the force applied by the user so as to generate the minimal amount of friction required to clean teeth, the user merely needs to move the oral hygiene device near to the mouth and the magnetic field will activate so as to apply the force needed to clean teeth, by means including but not limited to the user depressing a button, receiving an audio command from the user, or camera's on the unit designed to recognize the proximity of teeth. In some embodiments the brush may be a motorized in order to achieve a full range of motion in which the response can be dampened, while also achieving enough rigidity to exert control and an amount of friction sufficient to clean teeth, the holder and the brush may be anchored together at their bases, via a universal joint, while still allowing a full 360-degree range of motion in one plane.

In other embodiments the apparatus may be an oral hygiene instrument holder (including but not limited to a toothbrush holder, floss pick holder, water flosser holder, or tongue cleanser holder) with an adjustable force dampening or force applying setting. In some such embodiments the force and or direction of the instrument held, and or the means of coupling the instrument to the holder, may include but are not limited to a clamping mechanism in some such embodiments utilizing a plurality of tongs attached to the holder to grasp the instrument, an elastic grasping mechanism utilizing one or more elastic mechanisms to twist and tighten around the instrument thus holding it in place and/or directing it, a magnetic coupling mechanism magnetically attaching itself to one or more magnets on the instrument allowing the holder to direct the instrument, and/or a screw in mechanism allowing the instrument to be screwed into the holder one of the two having a male connection component and the other a female.

Some other embodiments of the present disclosure may involve a motorized scrolling device which can scroll along the user's gum-line. In some such embodiments the motorized scrolling device may have a plurality of brushes which may utilize the force dampening and applying technology to clasp around the user's teeth as it scrolls back and forth along the row of teeth it is attached to. In certain embodiments the turning of certain brushes may allow the motorized scrolling device to move from one tooth to the next. In certain embodiments the device may have a liquid containment chamber which may be utilized to apply a variety of pastes, gels or liquids to user, including but not limited to toothpaste, mouthwash, or peroxide whitening. In other such embodiments the motorized scrolling device may have a bar connecting one or more such devices, such that when a particular motor on the device turns, components including but not limited to gears, pulleys, or magnets will allow the device to propel itself along the bars as it scrolls along the user's gum-line. In certain embodiments the scrolling device may further comprise a floss drawing system allowing the device to pull floss from one end of the device to another as it scrolls, such that as the device moves along the gum-line, clean floss may be drawn into an opening, and pushed into the gaps between the user's teeth by mechanisms including but not limited to a piston system, a hydraulic system, or an additional motorized system. In other embodiments the scrolling device may include an instrument for bacterial disinfection, including but not limited to an ultra violet light emitter, a bacteria inhibitor, or an ionic generator.

Other embodiments of the present disclosure may be stationary devices such as a mouth guard, including components such as those found in the scrolling device embodiments. These may include but are not limited to a scrolling brush cleaner which moves along the contours of the mouth guard, a plurality of brushes within the stationary device which may apply force sensing technology, an ionic or ultraviolet emitter, fluid chambers and spraying devices for mouthwash or tooth whitening applications floss scrolling and injection or similar oral cleansing mechanisms. Any of the above-described embodiments may be varied in additional embodiments include charging mechanisms including but not limited to components for plugging them in, solar energy collection, rechargeable batteries that may be utilized with charging pads, replaceable batteries, or wireless charging mechanisms. Other variations may include wired or wireless transmission technology allowing a camera or programmed representation to display data including but not limited to a representation of the user's oral health, the force being applied, or the activity occurring in the user's mouth, on devices including but not limited to a cellular device, a television, or a wireless mirror.

Additional embodiments may involve data acquisition utilizing sensors including but not limited to cameras, temperature measuring device (including but not limited to thermometers, thermistors or thermocouples), timers, force detection, magnetic feedback detection, or position and velocity detection (including but not limited to inertial measurement unites (IMUs), gyroscopes or accelerometers). In some such embodiments a tooth efficacy clean AI algorithm may be utilized for means including but not limited to providing feedback for how well a user is cleaning their teeth, compare data between users, help one or more dentists to review information regarding users and/or make recommendations to users. In some such embodiments AI may be used to provide a standardized repeatable metric that will quantify the user's brushing habits in order to discuss with his or her dental professional. Tooth efficacy clean (TEC) is a work-based algorithm that measures how effective a user is brushing his or her mouth in real time. In some embodiments this algorithm only requires the following data points: position, time, and pressure, and when aggregated over time can be used to instantly provide feedback to the user and allow a dental professional to use artificial intelligence to assess whether the user has completed adequate cleaning since the last visit. These insights provide actionable recommendations as to how the well the user is cleaning and can improve their performance without damaging their gum-line, enamel and or other important oral health factors over time. In some other embodiments additional mechanisms may be utilized for the improvement of the toothbrush including but not limited to the aforementioned magnetic charger with a floating effect, an ultraviolet cleaner, or an internal dampening mechanism. Another embodiment may include but is not limited components such as a brushing stem with temperature, motion and/or pressure sensors, a removable brush head that slides over the stem and locks into place, a magnetic ring and base, one or more dampening pads or shock absorbers, a plastic modeled holder containing a battery, oscillator, data acquisition technology and/or gyroscope, an electromagnetic storage container, charger and ultraviolet cleaner, and/or an application that can sync with the device via electromagnetic communication means including but not limited to Wi-Fi or Blue-tooth and display data on a GUI of a mobile device including but not limited to a cellphone, tablet or wireless mirror.

Embodiments of this disclosure relating to oral hygiene devices, including but not limited to toothbrushes and flossing devices will enable users to ensure that they are brushing or flossing in an optimal manner for the prescribed amount of time. The dampening mechanism implemented through means including but not limited to the use of a magnetic device, dampening pads, or springs will allow user to brush their teeth and gums longer with less abrasion and, as a result, less damage to tooth enamel and gums. This disclosure through leveraging motion sensing software will allow user to ensure that they are adequately covering their entire mouths, as well as being reminded to use target areas that their dental professional have mentioned, and finally the ability to even to receive advice on best practice brushing methods via some web enabled application. These practical improvements could, individually, all rapidly improve oral health care. Taken together they represent an advancement in the methods and practices used to maintain oral hygiene, however a radical advancement in oral health is the decoupling of forces imparted by the user on their teeth, this disclosure facilitates new and novel motions to transform what were once considered brushing mechanics into an ability to impart semi-autonomous motion to oral cavities and improve outcomes.

In embodiments involving the charging pad, the ability of device to impact the life of rechargeable batteries, alert users more quickly that an object is charged or provide a user with an attractive display that allows them to see an object from multiple angles at a certain point in time provide a utility that make investment in the field of disclosure a potential boon to society that could further spur development with the aid of protection from intellectual property. In some embodiments such as those related to electric vehicles, a system of batteries may be utilized to replace the existing system of charging vehicles. Additional embodiments involve extending the health of one or more users or assets utilizing sensors or devices incorporating sensors to detect errors, AI, ML or DL predict the best means of correcting said errors or preventing further damage, and in embodiments involving electric vehicle batteries, sensors to detect when a tool for autonomous replacement is in proximity so that a docking station can dislodge a battery and secure its replacement, in some embodiments charging and crediting the user appropriately in autonomous fashion, in some embodiments even guiding autonomous vehicles to the battery replacement site when it is detected that they are in need, via an intricate network of sensors, CPU's and databases.

Some embodiments of the electric-vehicle replacement battery including as described in the claims herein, comprise a vehicle which has an attachment carriage, which may be removable in some such embodiments, that can be used to hold one or more batteries. In some such embodiments these batteries may be flat so they can be lodged in the car's undercarriage between the wheels, using the carriage or docking station for protection. In at least one embodiment, the batteries comprise interchangeable parts so they can be recycled from one vehicle to the next. Some such installations would require the need for a network including sensors to detect when the battery has expended its useful life, is damaged and requires repair or removal from the system, is in need of maintenance, or what remaining charge is left in the battery.

Some such embodiments comprise battery replacement facilities, which operate similar to gas stations, only being used for the replacement of depleted batteries with charged batteries. In some such embodiments these facilities would operate in an autonomous or semi-autonomous fashion to ensure the battery is quickly removed from the docking station, which senses it is in proximity to a battery replacement unit and replaced with a charged battery, so the docking station can secure the replacement battery and the vehicle can operate again. In some such embodiments the facility may further comprise sensors and a computer system to detect the remaining charge in a battery and credit the vehicle replacing a battery with the remaining charge from said battery. Thus, if a user enters with a battery with 25% of its charge remaining, the station will autonomously detect this after it replaces the battery, and realizing that it only needs to charge the battery an additional 75% before placing it on the docking station of the next vehicle, credit the first vehicle owner 25% of the charge on the replacement battery it provided.

Similarly, if such a station were to detect that it had no batteries at 100% when the next vehicle stopped for replacement, it could inform the driver of said vehicle, for instance that it has a battery at 89%, and allow the driver to decide whether to replace their existing battery or not and receive a comparable discount to the remaining charge on the replacement and replaced batteries. In some such embodiments the vehicle docking station may include a bi-directional plug for recharging at a building, including but not limited to residential homes or commercial buildings. In some such embodiments if the building has a power outage and the one or more batteries has sufficient power, said battery may be used to provide power to the building or its emergency services. In other such embodiments the docking station or one or more of the batteries it contains may be removable to mount to a docking station.

While some embodiments of the disclosure are shown in the accompanying drawings, it to be understood that said embodiments are susceptible to modification and alteration while still maintaining the spirit of our disclosure.

### BRIEF DESCRIPTION OF THE DRAWINGS

Referring to the drawings, FIG. 1 is an illustration of an exemplary magnetic pad which operates on a timed basis for controlling levitation of an object in this case a cell phone.

FIG. 2 is an illustration of an exemplary magnetic pad which operates on a percent charged basis for controlling levitation of an object in this case a cell phone.

FIG. 3 is an illustration of an exemplary magnetic pad which operates on a timed basis for controlling levitation of an object in this case a toothbrush.

FIG. 4 is an illustration of an exemplary magnetic pad which operates on a percent charged basis before controlling levitation of an object in this case a toothbrush.

FIG. 5 shows a line drawing of a magnetic pad which is tethered to an object, in this case a cell phone, which it can continue to charge or not as desired while concentric magnetic rings can control the rotation of the cell phone at a desired angle.

FIG. 6 illustrates a line drawing of an object and holder with a magnetic connector between the two, in this case the object being a toothbrush, where the holder may act as the magnetic pad and attract or repel the toothbrush.

FIG. 7 is an illustration of an exemplary magnetic charging pad which operates on a timed basis for controlling levitation of an object in this case a cell phone and has a motor for rotating the magnetic pad and in tandem the floated object.

FIG. 8 shows a line drawing of a magnetic charging pad which levitates a charged object, in this case a motorized toothbrush, which it can float at an angle or not as desired while concentric magnetic rings can control the rotation of the toothbrush, controlled from the GUI of an illustrated app.

FIG. 9 illustrates a line drawing of a magnetic charging pad which levitates a charged object, in this case an electric car, which it can showcase with lights from the outermost ring or not as desired while concentric magnetic rings can control the rotation of the car as desired, controlled by a system of motors, gears and pulleys.

FIG. 10 illustrates a line drawing of a magnetic charging pad, in this case being an oral hygiene device which can levitate an object in this case the device being a motorized toothbrush which operates on principles of magnetic dampening to control force from a brush head using said dampening technology, as the charging pad is tethered two an outlet for charging.

FIG. 11 illustrates a line drawing of one charging pad, in this case an oral hygiene holder, with a chargeable battery, sitting on a charging pad for recharging said battery.

FIG. 12 illustrates a line drawing of an oral hygiene holder with a chargeable battery for controlling the movement of a repulsed magnetic toothbrush, or for controlling the transmission of a signal wirelessly displaying data related to a user's use of the device, in this case a representation of cleaning their teeth being displayed on a Wi-Fi/display enabled monitor.

FIG. 13 is a representation of an oral device regulated by an oscillation mechanism at the stem of the holder, wherein a spring provides the dampening force and the brush head is given rigidity due to a dampening bar.

FIG. 14 is a cross sectional representation of an oral device regulated by an oscillation mechanism at the stem of the brush, wherein dampening pads on either side of the brush stem are used to provide a safety factor to the user.

FIG. 15 is a side view representation of an oral device and holder which may act as a charging pad with some magnetic components.

FIG. 16 is a side view representation of an oral device and holder which may act as a charging pad with some magnetic components.

FIG. 17 is an orthogonal and a cross sectional representation of an oral device regulated by an oscillation mechanism, with dampeners, Bluetooth and various other features.

FIG. 18 is an orthogonal and a front and side representation of an oral device regulated by an oscillation mechanism, with a removable brush head which may have 360-degree mobility, sensors built in or various other features.

FIG. 19 is an exemplary flowchart showing the typical database hierarchy with data sent to and from a device including but not limited to a charging station, toothbrush or mobile device using an application which may process a variety of functions including but not limited to vocal commands, language translation, responses, ordering of replacement parts, scheduling dentist appointments, or letting a user know how well they or any family members in their home network database or in competition with them on a cloud database are performing functions including but not limited to cleaning their teeth or replacing their brush components.

FIG. 20 is a front and side representation of an oral device—in this case an electric toothbrush where motion detected by sensors including but not limited to cameras or IMUs can activate the brush or triggers a specific oscillation motion.

FIG. 21 is a front and side representation of an oral device—in this case an electric toothbrush where one or more toothpaste cartridges can be inserted into the unit for cleaner more efficient brushing.

FIG. 22 shows a line drawing of a motorized toothbrush, fitted with one or more sensors, one or more of which may interface with and/or be controlled by a GUI interface.

FIG. 23 is a side representation of an oral device—in this case a travel, take-to-work, electric tooth-brush, which includes a compact design, which may be compressible by means including but not limited to a foldable joint or a telescoping design, such that it could more easily fit into a small compartment.

FIG. 24 is a side representation of an oral device—in this case a travel, take-to-work, electric tooth-brush, which includes a compact design, which may be compressible by means including but not limited to a foldable joint or a telescoping design, such that it could more easily fit into a small compartment, and further contains an orifice for inserting one or more toothpaste cartridges for cleaner more efficient brushing.

FIG. 25 is a drawing of a q-tip style toothbrush where one or more ends may be fitted with a toothpaste cartridge or gel, which may turn to a liquid or paste once bitten or inserted in a user's mouth.

FIG. 26 is an orthogonal and a cross sectional representation of a sensor driven shoe and an oral device both respectively fitted with health monitoring sensors including but not limited to IMUs, dampeners, Bluetooth and various other features.

FIG. 27 is an orthogonal and a cross sectional representation of a sensor driven shoe and an oral device both respectively fitted with health monitoring sensors including but not limited to IMUs, dampeners, Bluetooth and various other features, which may interface with and/or be controlled by a health-related GUI interface.

FIG. 28 is a drawing of a vehicle with a battery docking station located between an electric vehicle's tires, transmitting a signal for battery placement between a sensor located on the docking station and a sensor located in a battery replacement facility.

FIG. 29 is an exemplary flowchart showing the typical database hierarchy with data sent to and from a device including but not limited to a Battery Replacement Facility Sensor and an EV charging device which may process a variety of functions including but not limited to battery sensing, detection of an external replacement battery, guidance for releasing the stored battery, sensing whether a power outage has occurred at a house, and letting a user decide whether to send a portion of energy from a vehicle battery to power a house as needed.

FIG. 30 illustrates a line drawing of a battery replacement or servicing facility which senses a battery in a nearby device, in this case an electric car, which it can transmit information between to allow for servicing or replacement as needed.

FIG. 31 is a drawing of a building being used to charge a replaceable vehicle battery using a bi-directional Alternating Current adapter which can also be used to send power from the electric vehicle replacement battery to the house in the event of a power outage.

FIG. 32 is a drawing of a building with a replacement battery docking station allowing for reserve power for the house in case of an outage, or replacement of a vehicle battery and swapping with and charging of a vehicle battery in need of charging.

FIG. 33 is a side view of a vehicle with a battery docking station located between an electric vehicle's tires, with the battery replacement or servicing facility also sending financial information between the electric vehicle and the station in order to charge a fee for service or replacement and calculate a credit based on collection of a battery that has a remaining charge.

FIG. 34 is an exemplary flowchart showing the typical database hierarchy with data sent to and from a device including but not limited to a Battery Replacement Facility regarding cost processing which may process a variety of functions including but not limited to fee or credit processing, utilizing the electric vehicle or the battery replacement facility's network or the internet, and may operate a financial interface for charging a vehicle owner, user or an automated account.

FIG. 35 is a side view of a vehicle with a battery docking station located between the vehicle's tires, with the battery replacement or servicing facility further comprising a storage container, in this case being located underground, for storing one or more replacement batteries, and further comprising one or more automated servicing devices for removing batteries from the vehicle's docking station for charging and replacing batteries with one of the batteries located in the storage container.

FIG. 36 is a cross sectional view showing a battery docking station located between an electric vehicle's tires, said docking station further comprising a docking port for connecting with and allowing the transfer of energy from a rechargeable battery which may be synced with said electric vehicle, said rechargeable battery further comprising an interfacing port with which to transfer energy to said electric vehicle, or absorb energy from a charging port at a charging location including but not limited to a battery replacement or servicing facility or a battery docking station.

FIG. 37 is a side view of a vehicle with a battery docking station located between the vehicle's tires, wherein said docking station further comprises a series of batteries of non-rectangular shape, with the battery replacement or servicing facility further comprising a storage container, in this case being located underground, for storing one or more non-rectangular replacement batteries, and further comprising one or more automated servicing devices for removing batteries from the vehicle's docking station for charging and replacing batteries with one of the batteries located in the storage container.

FIG. 38 is an illustration of an exemplary transportation device with a battery mounted to it for the storage of energy.

FIG. 39 is an exemplary flowchart showing the typical database hierarchy with data sent to and from a mobile device using an application.

FIG. 40 illustrates an exemplary embodiment of a GUI of a potential navigational directory for locating items service centers or battery replacement centers, said GUI further comprising space for switching between autonomous electric-vehicles in a fleet.

FIG. 41 is a depiction of an exemplary guidance system in which a vehicle, including but not limited to an autonomous or semi-autonomous electric vehicle, or shopping cart, may be guided to a center, including but not limited to a service center, battery replacement center or vehicle charging station.

FIG. 42 illustrates an exemplary solar docking station for multiple vehicles, adjacent to a service center.

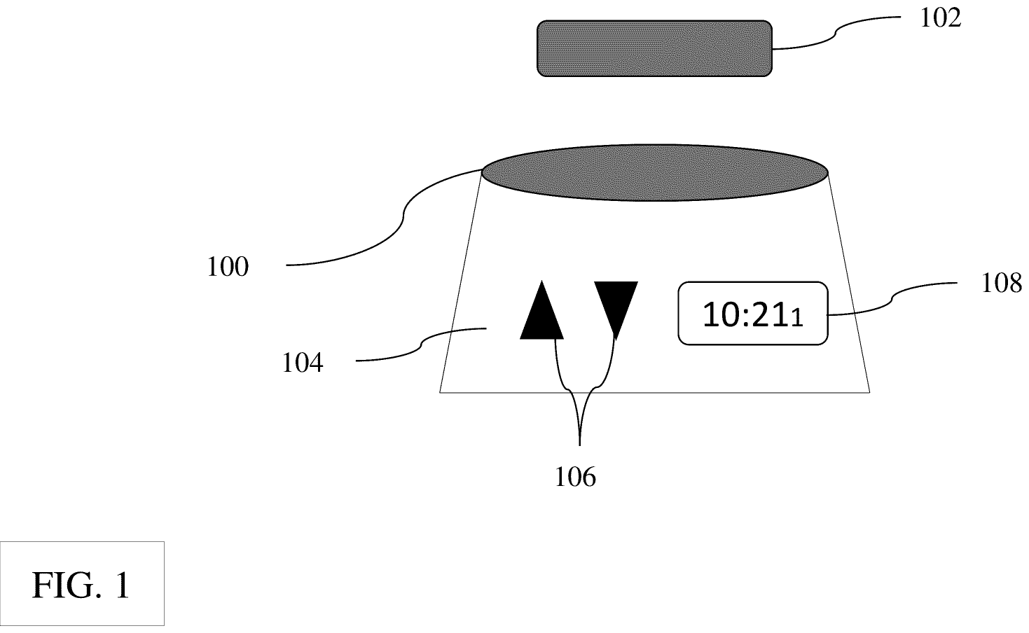

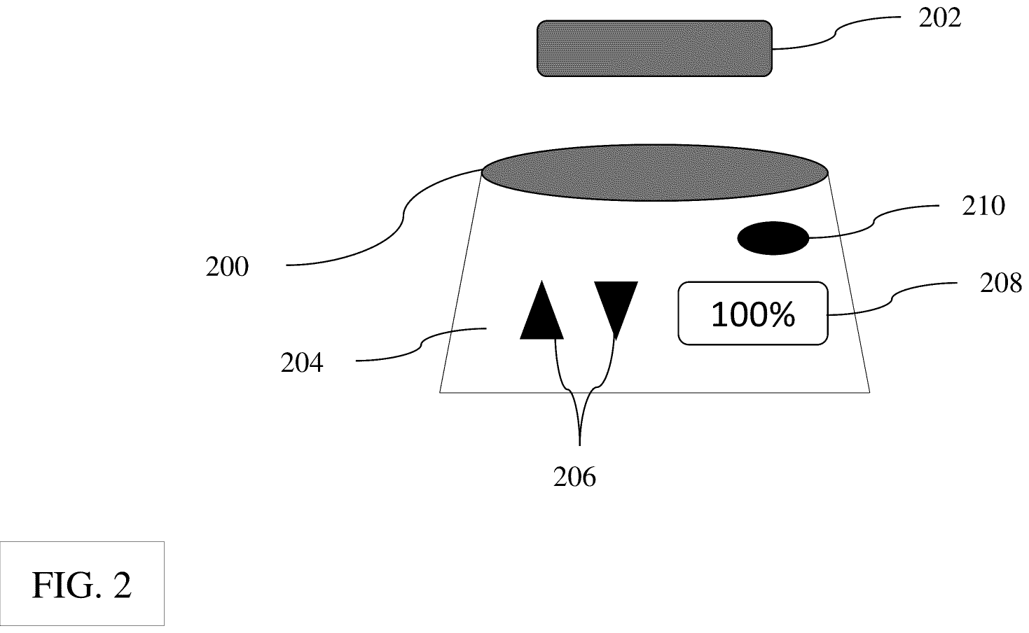

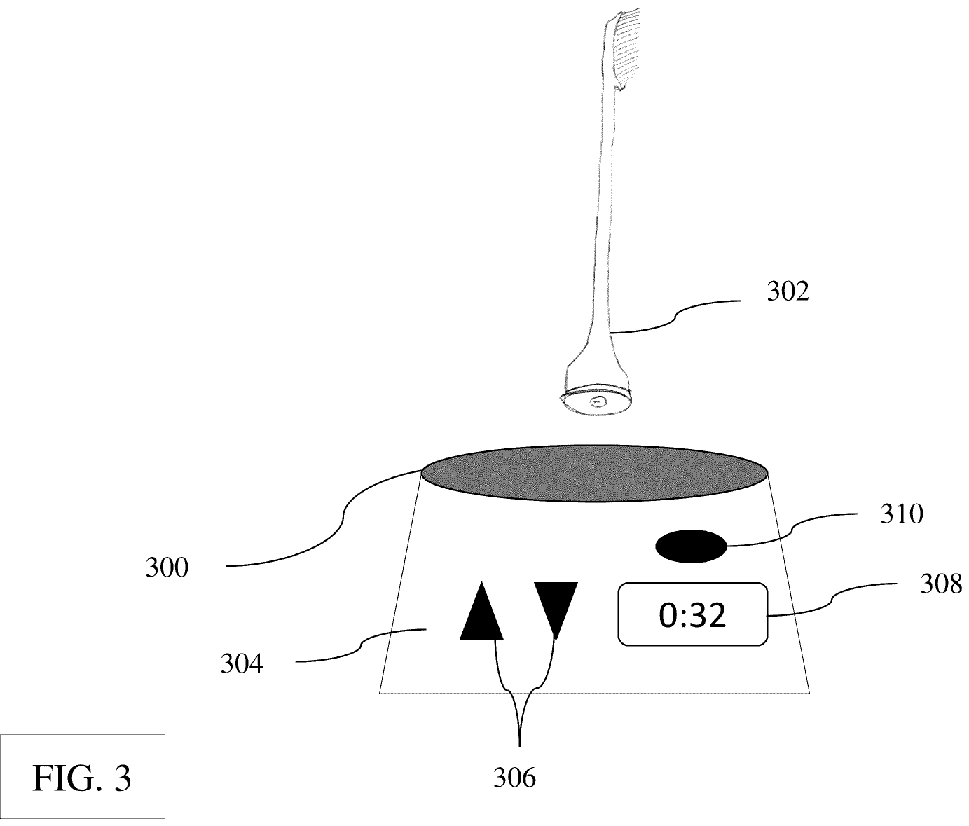

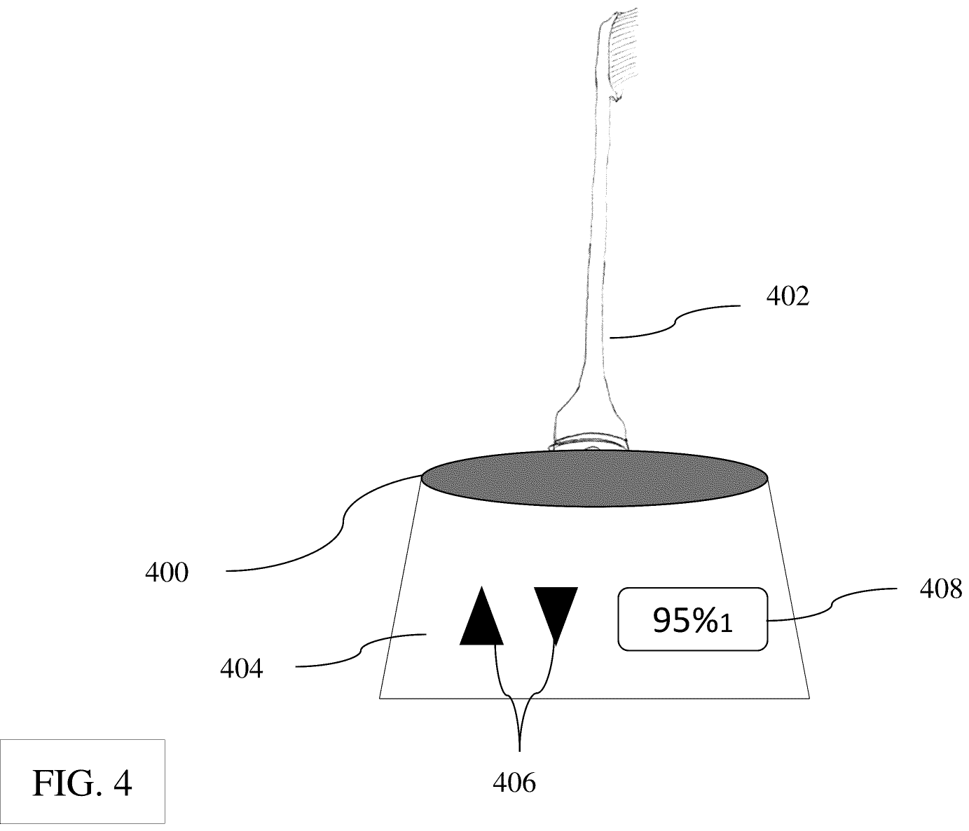

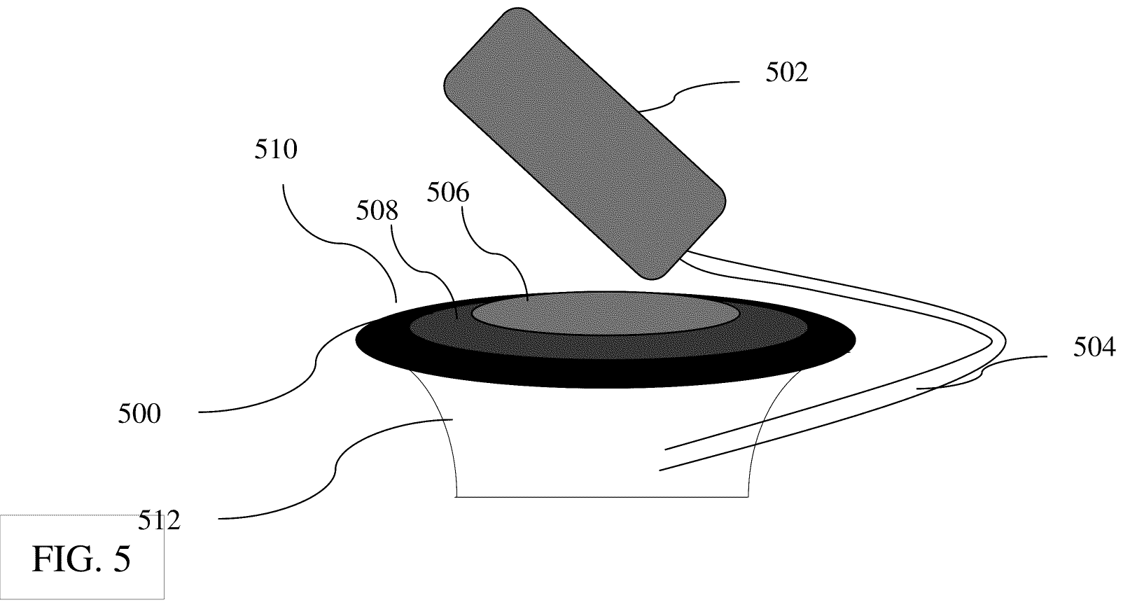

### DETAILED DESCRIPTION

The disclosures herein relate to the design of one or more battery monitoring or maintenance devices in some embodiments including guidance for autonomous vehicles for recharging, service or replacement of batteries or related devices. These devices may include but are not limited to devices that monitor and/or maintain the health of batteries or related devices that monitor and/or maintain the health of assets. The devices include batteries for vehicles, oral hygiene devices, smart-clothing with integrated batteries and sensors and charging pads which may monitor the health or assets being charged. Sensors may be integrated in these devices including but not limited to IMUs, thermocouples or oral cleaning devices, IMUs in clothing like shoes or wrist bands, or timers or charging sensors in magnetic surfaces which may cause one or more objects and/or other magnetic surfaces to float when a desired function is achieved.

In this disclosure battery monitoring or maintenance devices may be devices may include but are not limited to devices that measure the remaining charge left in a battery, the number of recharges left in the battery's useful life, damage to the battery, abrasion on the battery or other needs of a battery signifying repair or replacement is in order of the battery or its method of charging or discharging energy. Some embodiments of this disclosure further comprise guidance systems for autonomously or semi-autonomously directing a vehicle, user or battery servicing device to a battery service center, to the battery itself or to one or more selected items in inventory. In this disclosure the term ‘oral hygiene device’ refers to any device which may be used for the maintenance of a user's mouth, including but not limited to a toothbrush, a motorized toothbrush, a floss pick, a water flosser, a tongue scraper, a scrolling toothbrush, scrolling flosser, or a stationary mouth guard further comprising components including but not limited to motorized brushes, dental debris suction devices, bacteria removing cloth wipers, ionic emitting cleansers, ultraviolet light, liquid chambers and nozzles to spray mouthwash, peroxide tooth cleanser, toothpaste, or other oral cleansing liquid, gel, or paste, scrolling mechanism, or any combination of the aforementioned. In this disclosure, the term ‘scrolling’ refers to embodiments of the apparatus that involve mechanisms for moving devices along the gum-line. In the case of a scrolling toothbrush this may include a tooth-brush assembly of a plurality of brushes, which may be circular and motorized facing opposite angled or perpendicular directions and utilize the mechanical methods of propulsion including but not limited to the rotation of said brushes to move in some embodiments, a motor, wheel or pulley system along a track or mouth guard to move in others. In the case of a scrolling flosser or combination scrolling tooth-brush with a flosser the device may utilize the same means of propulsion as a scrolling tooth-brush, but comprise a component allowing a spool of floss to move from one side of the gum-line to the other, effectively allowing a fresh piece of floss to clean out one gap to the next as the floss moves in and out accomplished by mechanisms including but not limited to any combination of motorized pistons and spoolers, compressed gas driven pistons, hydraulic pistons, magnetic pistons, pulley driven spoolers or a single piece of floss held in a floss pick that gradually shifts from the front of the teeth gap to the back as it moves along the gum-line, and is replaceable. The scrolling flosser may be disassembled to allow a new spool of floss to be utilized in some embodiments. In some embodiments, the scrolling flosser may include a sensor that detects caps between the user's teeth and sends a signal to the scrolling mechanism to stop the floss there, press the floss into the user's gum until the desired pressure is achieved and retract the floss, restarting the scrolling to the next gap.

Some embodiments of the disclosure comprise a dampening mechanism. The dampening mechanism may be as simple as means including but not limited to an adjustment mechanism for the scrolling toothbrush design that gives the parallel facing brushes enough play to glide along the user's teeth while applying enough pressure to adequately brush them utilizing means including but not limited to gears and clamps, moving in a limited range of motion, elastics or springs pressing the brushes with limited resistance into the user's teeth, a mouth guard device adjusting the pressure used by a suction device to pull bacteria from user's teeth, emit a jet of plaque removing liquid with regulated force, or any combination of the aforementioned to provide a limited present amount of pressure, or as complex as a magnetic oral hygiene device holder comprising a magnet stem which may be attached to the detachable base of a magnetic oral hygiene device such as toothbrush or tongue scraper with a magnetic base, said oral hygiene device further comprising a direction mechanism with a magnetic field adjuster which may be one of a variety of designs including but not limited to a dial adjusted mechanism directly attached to the oral hygiene device holder, a digital remote adjustment mechanism allowing the user to set the range of pressure applied, or a combination device involving a sensor in the attachment mechanism which sends a signal to the holder the moment resistance is detected and the holder responds by increasing the magnetic field in order to apply the desired pressure to teeth or gums that the oral hygiene device is touching. In some of the magnetic embodiments when a user applies a given force to the holder, the magnetic field will provide a force equal and opposite of the direction provided by the user, less the force necessary to generate the minimal amount of friction required to clean teeth. The counter-balancing effect ability of the control system allows the user a regular an unmodified force without ever exceeding the desired magnitude of force desired. In other such embodiments instead of the force applied by the magnetic field being less than or equal to the force applied by the user so as to generate the minimal amount of friction required to clean teeth, the user merely needs to move the oral hygiene device near to the mouth and the magnetic field will activate so as to apply the force needed to clean teeth, by means including but not limited to the user depressing a button, receiving an audio command from the user, or camera's on the unit designed to recognize the proximity of teeth. The attachment mechanism is a means of affixing the oral hygiene device holder to the oral hygiene device. The oral hygiene device holder may be shaped as one of several designs including but not limited to a tube, a platform, or a mouth guard. In some embodiments the attachment mechanism may be one of or any combination of the following including but not limited to a clamping mechanism in some such embodiments utilizing a plurality of tongs attached to the holder to grasp the instrument, an elastic grasping mechanism utilizing one or more elastic mechanisms to twist and tighten around the instrument thus holding it in place and/or directing it, a magnetic coupling mechanism magnetically attaching itself to one or more magnets on the instrument allowing the holder to direct the instrument, and/or a screw in mechanism allowing the instrument to be screwed into the holder one of the two having a male connection component and the other a female. In some embodiments, the oral hygiene device holder may be charged by means including but not limited to plugging the device directly into an outlet, in others it may be tethered by means including but not limited to a lightning cable, usb, or plug to an outlet, battery or charged device, or placing it on a charging pad, the device comprising a rechargeable battery compatible with said means in some such embodiments. In some embodiments, the disclosed device may include a motion sensor and/or a motion response mechanism allowing the device to autonomously react to motion within the user's oral cavity in means similar to the pressure dampening mechanism response, but which in some embodiments may also include adjusting the pressure applied by the device. In some such embodiments, the device may include a light and vibration pressure regulation mechanism, which may allow the device to adjust the amount of ultraviolet or visible light emitted, allowing the user to see and/or to neutralize bacteria harmed by ultraviolet radiation, or to regulate the pressure generated by the device vibrating as the user's mouth is cleaned. This may most easily be visualized in the mouth guard embodiments. In some such embodiments, the device may also include vibration and lighting indicators, allowing the device to autonomously respond in adjusting the light and vibration pressure regulation mechanism. In other embodiments the device may comprise a web enabled device that transmits or records data associated with usage. This may allow the device to send a signal showing data including but not limited to a camera showing the users mouth or a representation of the users mouth, health data concerning the users mouth, or data related to the performance of the oral hygiene device, and transmitting it an output device including but not limited to a cellular phone, tablet, television, computer, virtual reality glasses, augmented reality glasses, or a smart mirror my means including but not limited to Bluetooth, Wi-Fi, or usb. In some embodiments the device may be a scrolling brush containing components such as a timer allowing it to keep track of how much time is spent on each tooth, a top scroller allowing it to scroll along the top and bottom teeth simultaneously, or further comprising a scrolling mechanism capable of adjusting the displacement between top and bottom rows of teeth brushes so that one of the scrolling brushes moves laterally as both move horizontally adjusting for the difference in lateral space between the top and bottom teeth as the scrolling brushes move. These adjustments may be made by means including but not limited to malleable wires, gaps on a track directed by wheels, or a string that both brushes move along while attached to one another via elastic bands.

Additional embodiments include data acquisition utilizing sensors including but not limited to camera devices, thermometers, timers, force detection, magnetic feedback detection, accelerometers or position and velocity detection. Some such embodiments involving camera devices may utilize camera devices including but not limited to pinhole cameras in the brush head, borescope cameras above the brush head, or photoelectric sensors, which may be used for means including but not limited to spotting damage in a user's mouth, comparing user's teeth overtime, comparing users cleaning efficiency vs other users, taking scans of a user's mouth for review by one or more dentists, or spotting and preventing gum disease, plague buildup or visual indications that a user is getting sick. In some such embodiments a tooth efficacy clean AI algorithm may be utilized for means including but not limited to providing feedback for how well a user is cleaning their teeth, compare data between users, help one or more dentists to review information regarding users and/or make recommendations to users. The tooth efficacy clean AI may involve some form of machine learning in some such embodiments for means including but not limited to gathering data from multiple users, comparing data from one user over time or some combination therein. Some such embodiments ay involve an external app with a GUI that compares users' performance to other users for competitive purposes. In some other embodiments additional mechanisms may be utilized for the improvement of the toothbrush including but not limited to the aforementioned magnetic charger with a floating effect, an ultraviolet cleaner, or an internal dampening mechanism. In some embodiments a magnetic charger with a floating effect may involve a charging stand for a brush that can use the repulsion of the magnetic charging surface to cause the brush to float, as an oppositely charged surface pushes off of an activated electromagnetic charger. In some such embodiments a brush may be dropped by a user and floated by the charger before the electromagnet powers down to lower the brush automatically onto the charger. An embodiment may include but is not limited components such as a brushing stem with temperature, motion and/or pressure sensors, a removable brush head that slides over the stem and locks into place, a magnetic ring and base, one or more dampening pads or shock absorbers, a plastic modeled holder containing a battery, oscillator, data acquisition technology and/or gyroscope, an electromagnetic storage container, charger and ultra violet cleaner, and/or an application that can sync with the device via electromagnetic communication means including but not limited to Wi-Fi sensors, blue-tooth sensors or other electromagnetic communications device and display data on a GUI of a mobile device including but not limited to a cellphone, tablet or wireless mirror.

In this disclosure the term ‘electro-magnetic surface’ refers to any device comprising one or more electro-magnets, permanent magnets, wireless charging pad or some combination therein, one or more may be activated by means including but not limited to an electric charge, release/movement of a magnetic shield, or electromagnetic pulse. In this disclosure, the term ‘object’ refers to one or more devices which may be levitated or charged by the electro-magnetic surface, including but not limited to a toothbrush, cell-phone, car, cell phone case with magnetic shielding to protect the cell phones components, cell phone holder which may be charged by the electro-magnetic surface such that it can activate an additional electro-magnet to move a brush from its holder or a host of other embodiments. Some embodiments of the present disclosure may be as simple as an electro-magnetic surface which raises a repelled magnetic pad with a company logo on it and spins it around or puts lights on it, or as complex as an electro-magnetic surface which is embedded in a roadway such that it can charge a vehicle including but not limited to an electric car, hydraulic-electric cart or solar-electric aircraft's battery while using a system of magnets and receptors to detect balance of the vehicle on the roadway and provide feedback to the vehicle dashboard regarding issues including but not limited to alignment issues, structural damage, or suitable aerodynamic enhancements to improve performance.

Some embodiments of the present disclosure include but are not limited to a magnetic pad that has a wired connection to a floating object. In some such embodiments the wired connection would be used for means including but not limited to charging the object, serving as a tether to the object, guiding the spin of the object along a pathway the tethered line moves across, or some combination therein. Some such embodiments may include the use of an electromagnetic tether. Some such embodiments allow for some movement of the object including but not limited to circular motion, tumbling, or raising/lowering in response to criteria including but not limited to the object reaching a certain charge, the object being placed on the magnetic pad for a certain amount of time, or a user inputting a command. Other embodiments of the present disclosure comprise an object that charges while flat on a wireless charger. In some such embodiments the wireless charger comprises two or more fields at least one for magnetic levitation of an object and at least one other for charging an object. In some such embodiments said fields may not operate simultaneously. Some such embodiments utilize electromagnetic means of communication including but not limited to Bluetooth, Wi-Fi, or NFC bands. In some such embodiments the magnetic pad may respond to a controller to switch between the modes including but not limited to imbedded controls, a remote controller, or application controls that may be directed by an application with a GUI on from a cellphone and allow users to select or input commands including but not limited to selecting that the object hovers when it has finished charging, that the charging pad implements machine learning, that the object charges via tether as opposed to utilizing a charging pad, or that the object spins at a certain rate. Yet other embodiments of the present disclosure may allow a wireless charging and magnetic pad device to activate both fields without any adverse interference allowing charging and levitation at some pre-defined distance. In some such embodiments the rate of charging may be slower when the object is levitating than when it is sitting on the magnetic pad. In some such embodiments a setting may be labeled any number of items including but not limited to responsive wave, night charging, or auto-float and may raise the object from the pad being able to allow a user to access it more quickly. In some such embodiments this mode may function by causing the object to raise in response to user motion including but not limited to the moment a user waves their hand, reaches for the object or is in close proximity to the object, allowing the user to grab the object more easily instead of fumbling for it. In some such embodiments the magnetic field may make adjustments automatically guide the object to its resting place or ideal charging place the moment the user lowers the object onto the charging pad.

In some embodiments of the disclosure the apparatus may be a magnetic pad 100 which levitates an object of opposing polarity, in this case a cellphone 102. The magnetic pad may further comprise a base 104, with room for buttons 106 to adjust a timer 108 which may control how long an object begins to float after it is detected in some embodiments or how long an object floats for in others. In certain embodiments, the cellphone may have a holder which comprises a permanent or electromagnet, in order to repel the electromagnet of the base magnet when activated, while providing shielding to the cell phone in some embodiments. In some embodiments, the base may serve as a charging pad and the timer can be set to cause the object to levitate after charging for a certain amount of time.

In some embodiments of the disclosure a magnetic pad 200 may levitate an object of opposing polarity, in this case a cellphone 202, and may further comprise a base, 204 with buttons 206 to adjust the desired maximum charge displayed 208 and a button to set or activate the electromagnet 210, causing the object to levitate once the desired charge is detected.

In some other embodiments of the disclosure the apparatus may be a magnetic pad 300 which levitates an object of opposing polarity, in this case a toothbrush with a magnetic base 302. The magnetic pad may further comprise a base 304, with room for buttons 306 to adjust a timer 308 which may control how long an object begins to float after it is detected in some embodiments or how long an object floats for in others. A button 310 may be used to change the mode in some embodiments for means including but not limited to activating such that the toothbrush will lift at desired points in the day to remind a user when to brush, detecting when the brush has sufficiently charged before lifting, or sensing the brush performance and lift it when it is suggesting to replace the brush.

In some embodiments of the disclosure a magnetic pad 400 may levitate an object of opposing polarity, in this case a toothbrush 402, and may further comprise a base, 404 with buttons 406 to adjust the desired maximum charge displayed 408 causing the object to eventually levitate once the desired charge is detected.

In yet other embodiments of the disclosure a magnetic pad, 500, may levitate an object in this case a cell phone, 502, which is powered via a tethered connection, 504, and rotated or angled by concentric magnetic rings, 506, 508, and 510, supported by a base, 512.

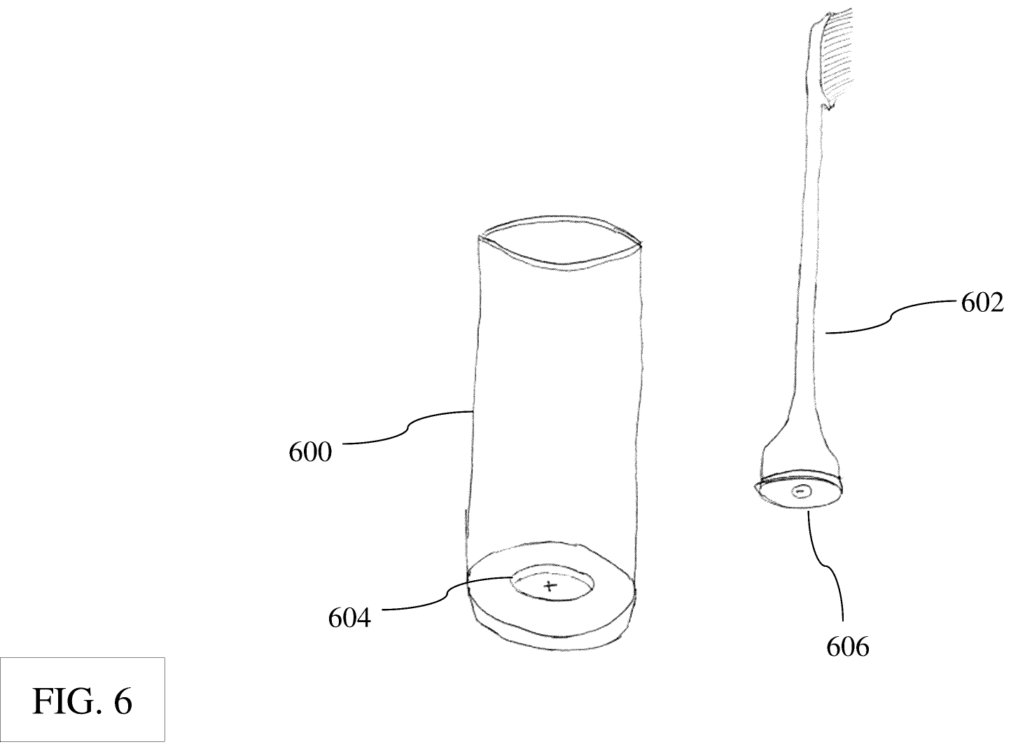

FIG. 6, illustrates an oral hygiene device holder 600, separate from an oral hygiene device, in this case a brush, 602, which may be attached to or levitated from the holder at a magnetic linkage, 604, matching a magnetic attachment on the brush, 606, the magnetic assembly allowing for force dampening as the user cleans their teeth.

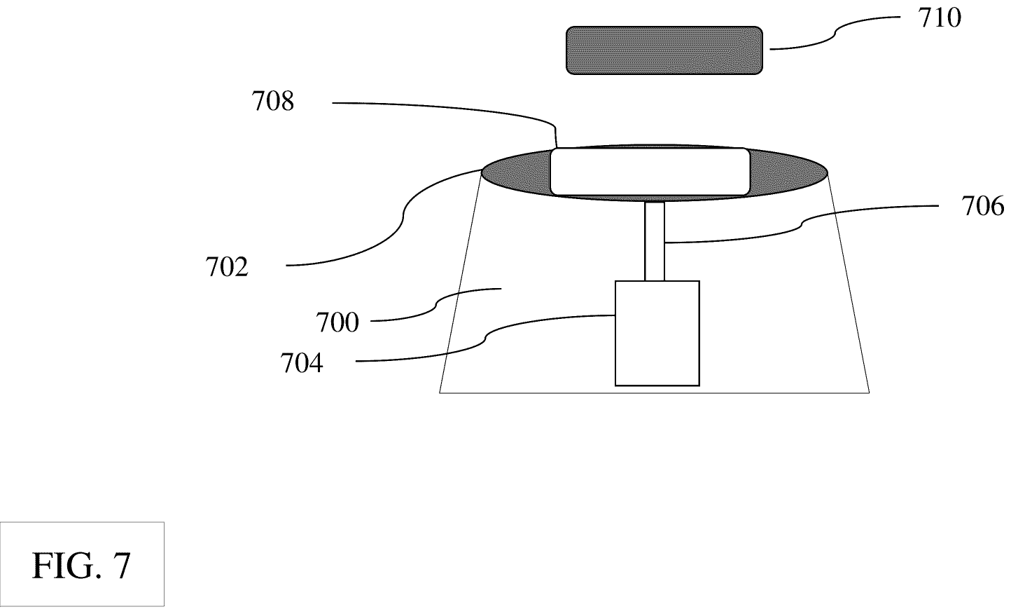

FIG. 7, illustrates a magnetic charging pad assembly 700, comprising a magnetic charging pad, 702, which may be turned by a motor 704, rotating a connected stem 706, the magnetic pad containing a slot 708 which may be utilized to house an object, in this case a cell phone 710, or cause it to rotate in tandem.

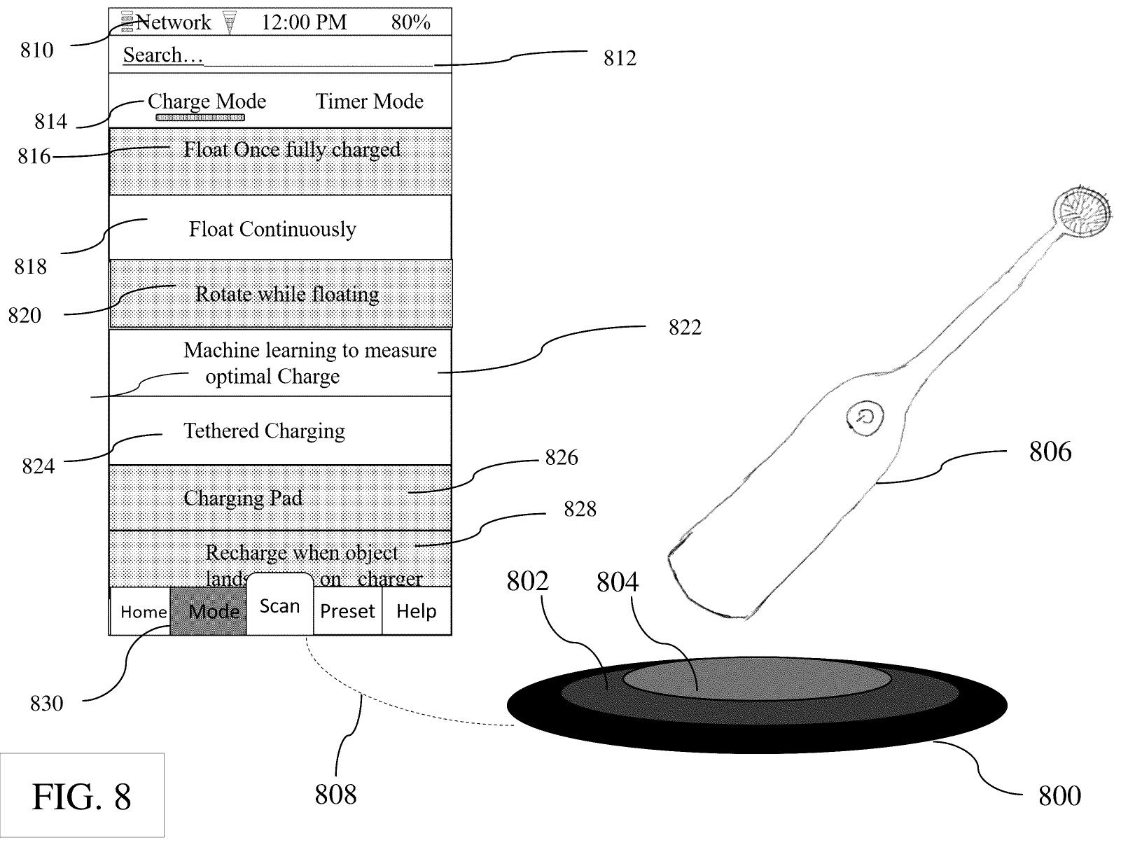

FIG. 8, illustrates a magnetic pad, 800 which may levitate an object in this case a toothbrush, 806, which is powered via a charging pad when it is not levitating, 804, and rotated or angled by concentric magnetic rings, 802. The assembly may be controlled wirelessly 808 by a user's GUI application 810, which allows the user to set whether the apparatus operates on a timer mode 812 or a charge mode 814. This application may give the user options such as setting whether the object is to be floated once fully charged 816, floated continuously 818, rotated while floating 820, whether the device should record data and act on it via machine learning to adjust how it floats the object to achieve a more optimal charge based on battery life and rechargeability 822, whether it should charge the object via tethered charging 824 as opposed to using the charging pad 826, and whether it should recharge the object when it lands on the charger or not 828. In this embodiment there are also options to change the menu on the GUI as the mode 830 menu is currently selected in the illustration.

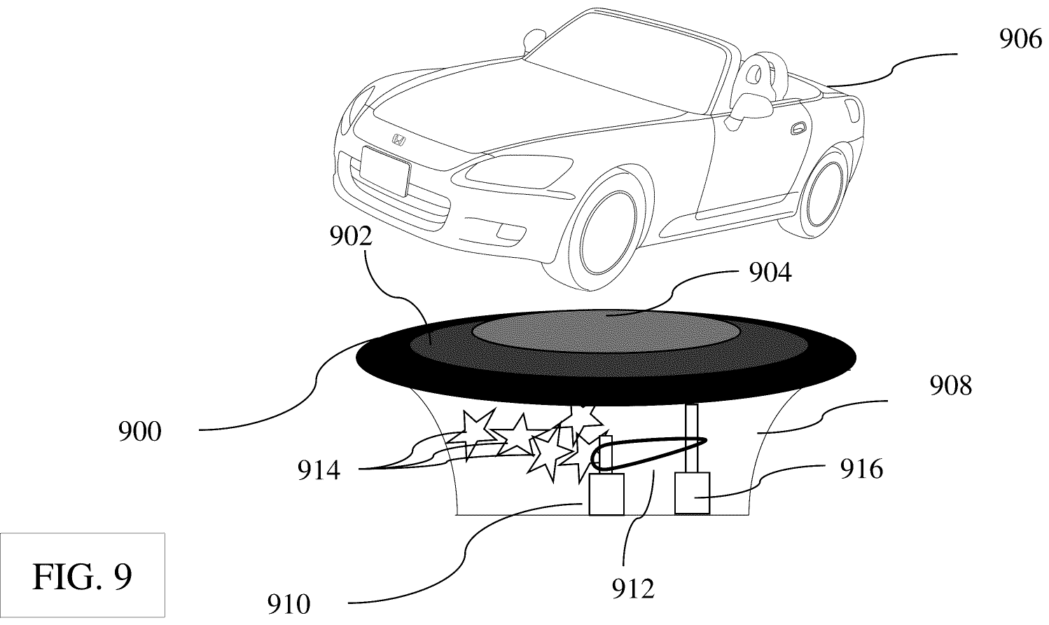

FIG. 9 illustrates a line drawing of a magnetic charging pad 900 which levitates a charged object, in this case an electric car 906, which it can showcase with lights from the outermost ring or not as desired while concentric magnetic rings 902, 904 can control the rotation of the car as desired, a controlled a system of motors 910, 916, gears 914 and/or pulleys 912, within the base housing 908.

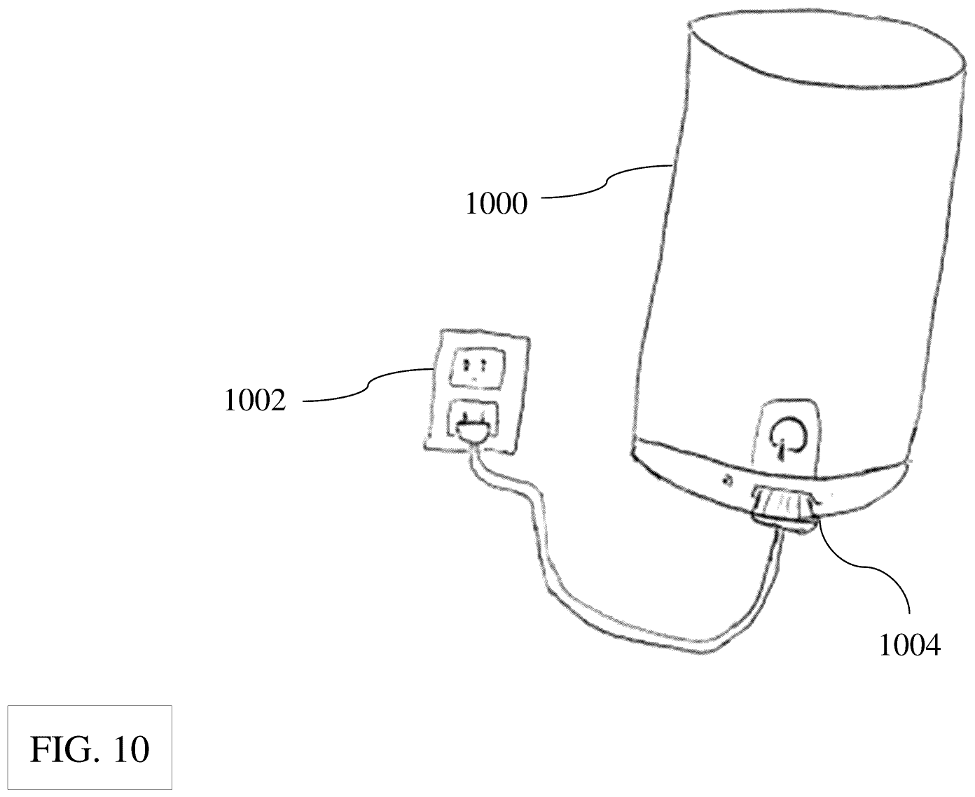

FIG. 10 illustrates a line drawing of a magnetic charging pad 1000, in this case being an oral hygiene device which can levitate an object in this case the device being a motorized toothbrush which operates on principles of magnetic dampening to control force from a brush head using said dampening technology, as the charging pad is tethered 1004 to an outlet 1002 for charging.

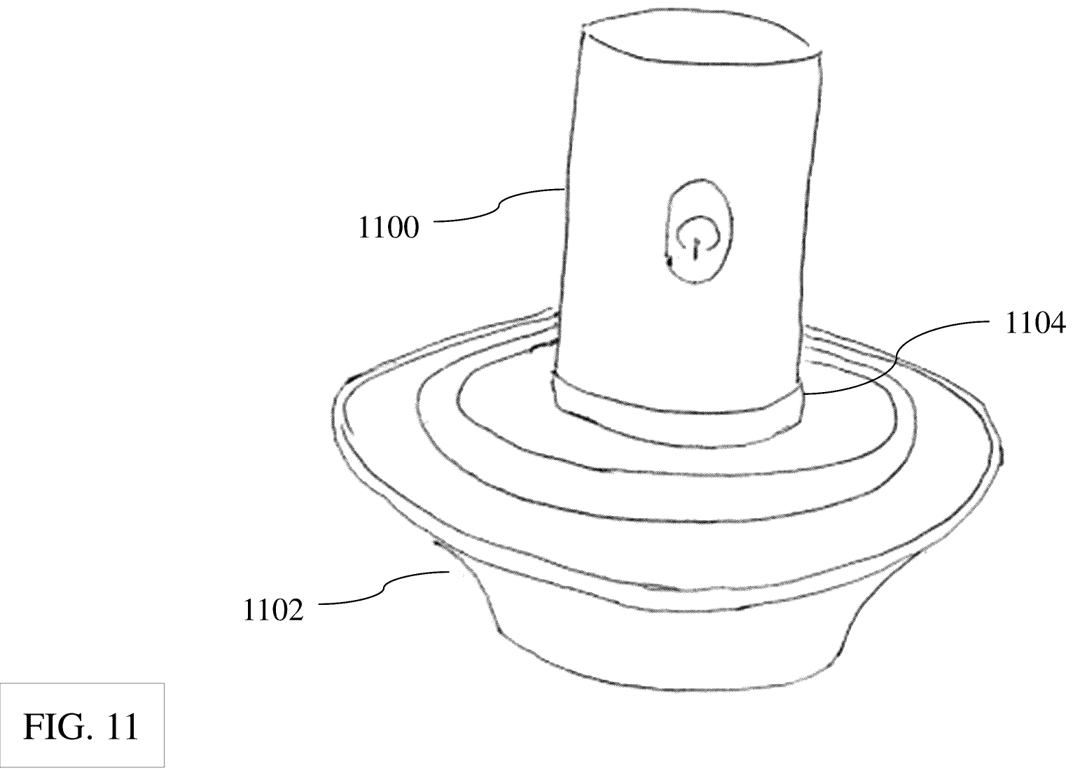

FIG. 11 illustrates a line drawing of one charging pad 1100, in this case an oral hygiene holder, with a chargeable battery 1104, sitting on a charging pad 1102 for recharging said battery.

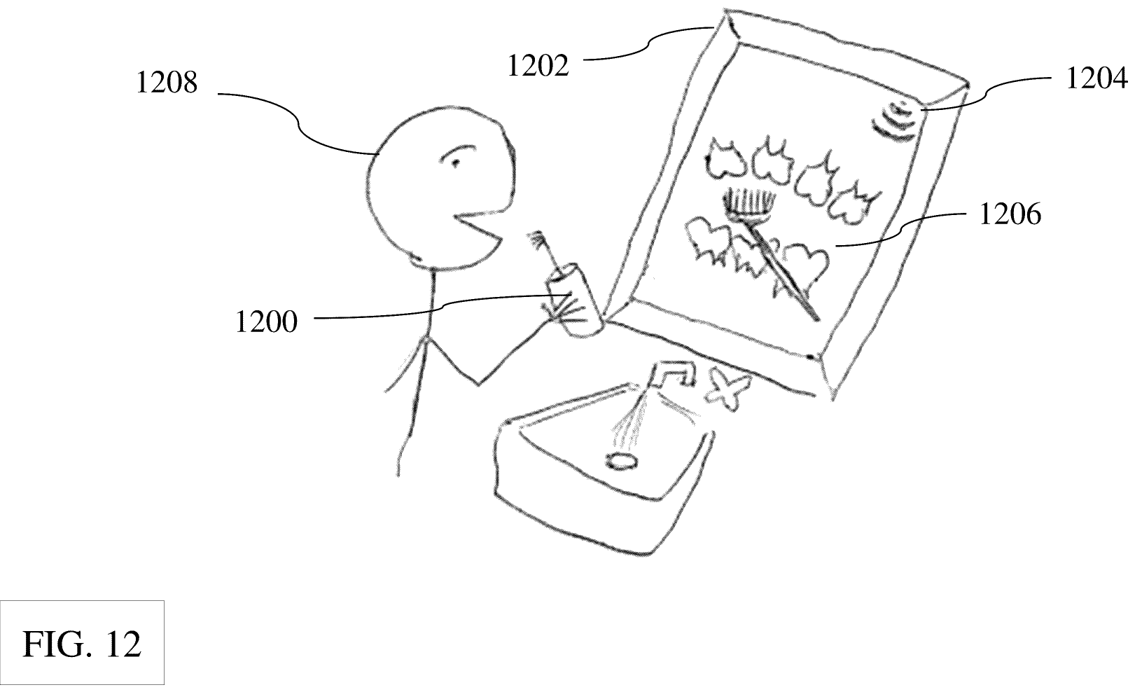

FIG. 12 illustrates a line drawing of an oral hygiene holder with a chargeable battery for controlling the movement of a repulsed magnetic toothbrush 1200, or for controlling the transmission of a signal wirelessly to a display device, in this case a wireless local area network or Bluetooth enabled mirror 1202, which may display a symbol to indicate a connection has been established, in this case a wi-fi symbol, 1204, as it displays data related to the user's oral health or the device condition, in this case camera footage of the user's mouth as it's cleaned, 1206, as the user, 1208, holds the oral hygiene device.

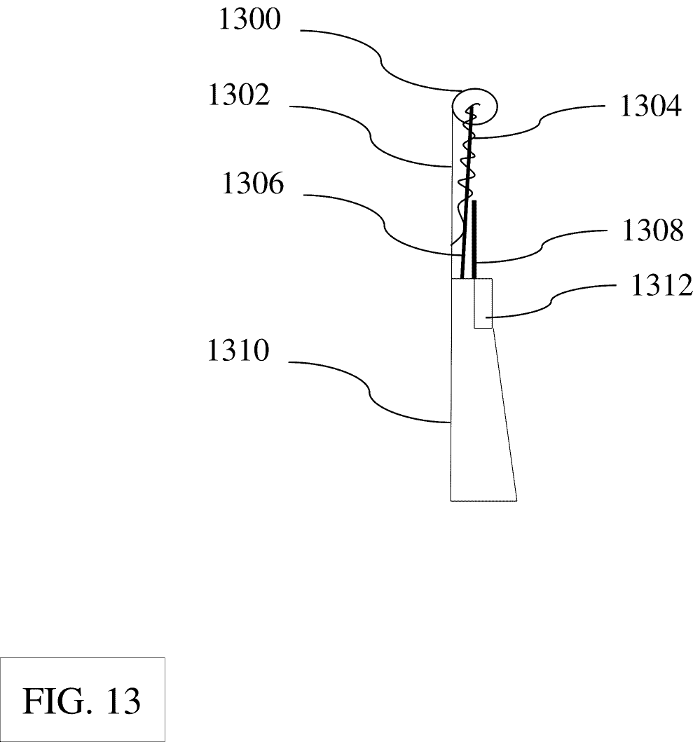

FIG. 13 illustrates a representation of an oral device 1310 regulated by an oscillation mechanism 1308 at the base of the stem holder 1312, wherein a spring 1304 provides the dampening force around a brush stem 1306 and the brush head 1308 is given rigidity due to a dampening bar 1302.

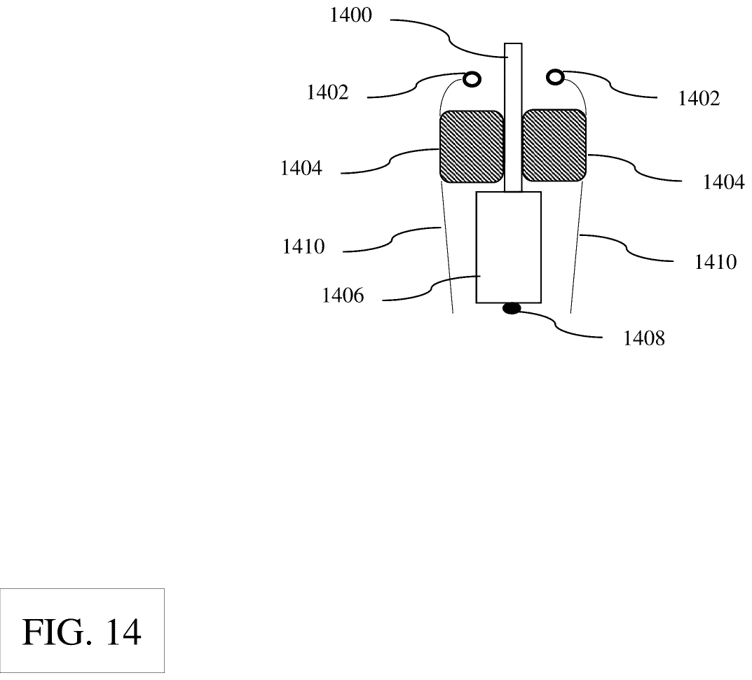

FIG. 14 illustrates a cross sectional representation of an oral device 1410 regulated by an oscillation mechanism 1406 with an oscillation pivot point 1408 at the stem of the brush, wherein dampening pads 1404 on either side of the brush stem 1400 are used to provide a safety factor to the user as magnets 1402 can guide the direction of the brush head.

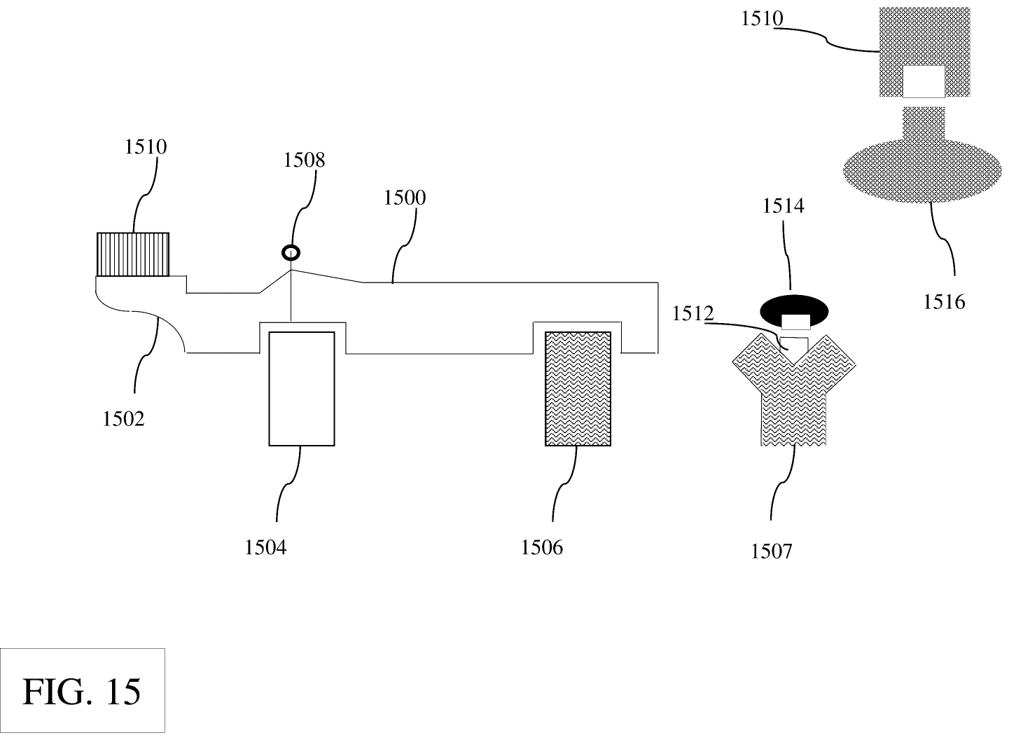

FIG. 15 illustrates a side view representation of an oral device 1500 and holder 1504 which may act as a charging station 1506 (or 1507 as seen from the side view) with some magnetic components 1512, 1516 which cause the oral device to lift a fitting part of the oral device 1510, 1514 as a brush head 1510 and stem 1502 may be guided by magnets 1508.

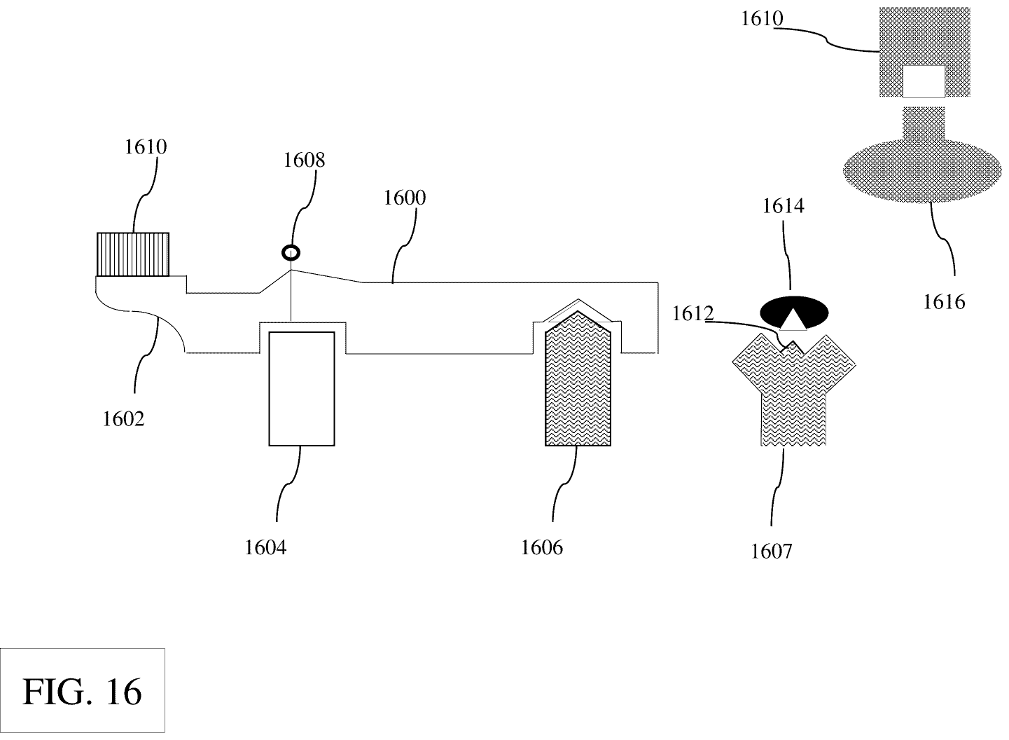

FIG. 16 illustrates a side view representation of an oral device 1600 and holder 1604 which may act as a charging station 1606 (or 1607 as seen from the side view) with some magnetic components 1612, 1616 which cause the oral device to lift a fitting part of the oral device 1610, 1614 as a brush head 1610 and stem 1602 may be guided by magnets 1608.

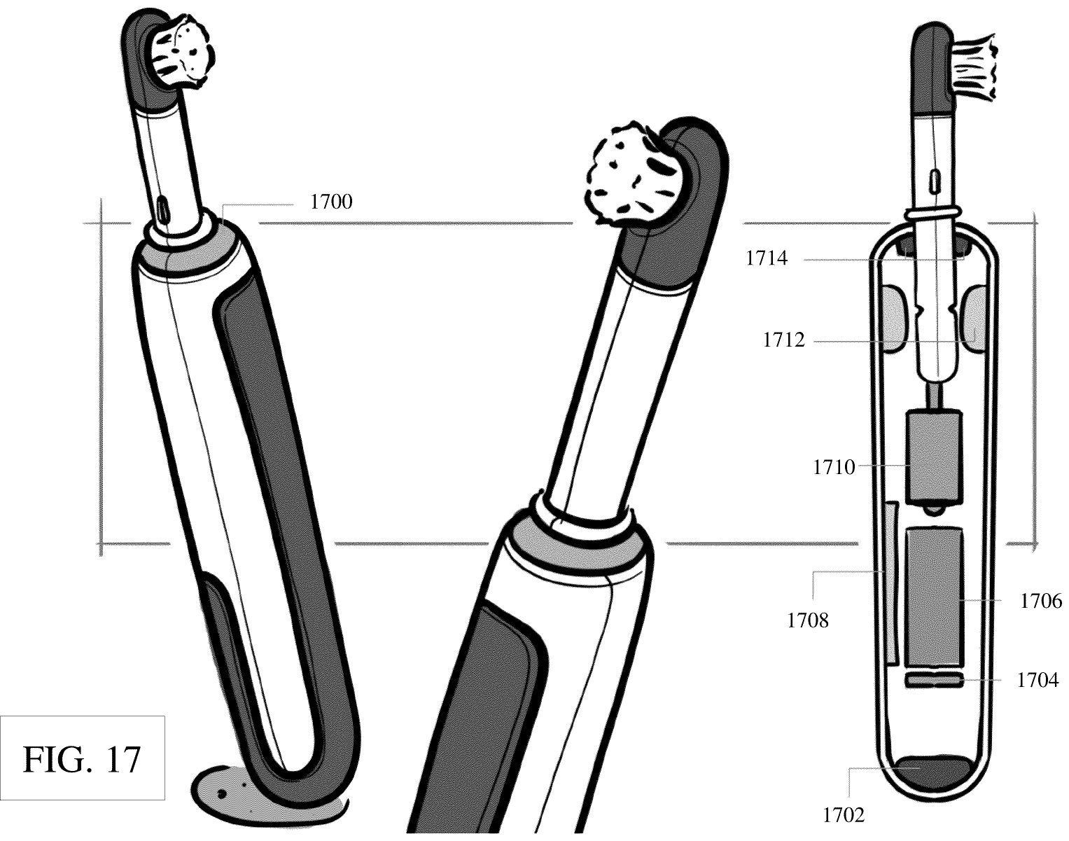

FIG. 17 illustrates an orthogonal and a cross sectional representation of an oral device 1700, with magnetic components 1702 for lifting from a charger, Bluetooth components 1704 for communication, a battery 1706 for powering the device, a charging module 1708 for charging the device, an oscillator 1710 for regulating the motion of the stem, dampers 1712 for reducing the force placed on the stem, or magnets to guide the brush head 1714.

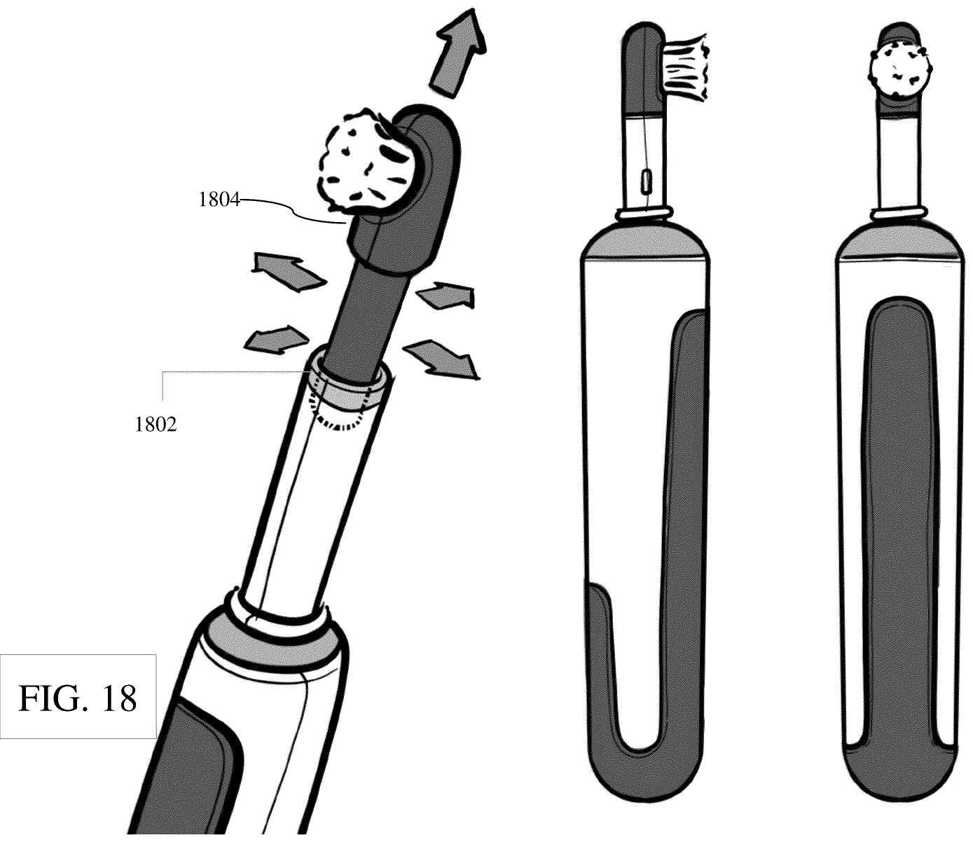

FIG. 18 illustrates an orthogonal and a front and side representation of an oral device regulated by an oscillation mechanism, with a removable brush head 1804 which may have 360-degree mobility, sensors built in 1802 or various other features.

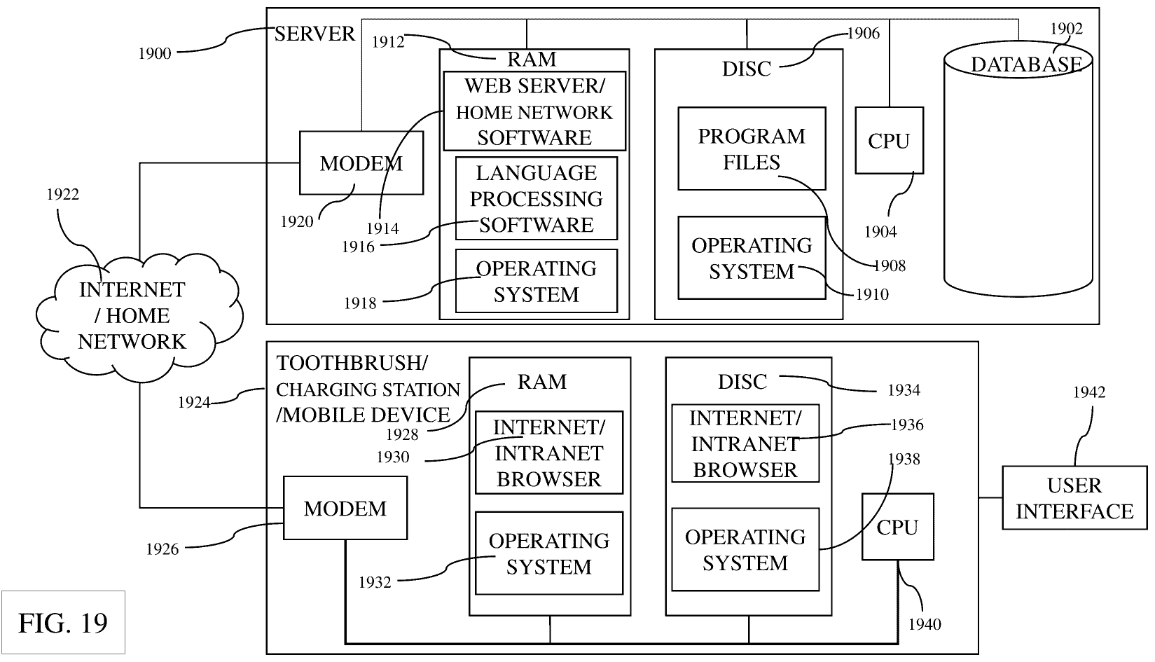

FIG. 19 is an exemplary embodiment following a standard Internet architecture in which one or more user's toothbrush/charging station/mobile device 1924 and a server 1900 are connected via the internet/home network 1922 and modems 1926, 1920 or other communications channels. A user accesses the server 1900 via their toothbrush/charging station/mobile device 1924 potentially via verbal commands operating a web browser 1930 or other software application residing in RAM memory 1908 that allows it to display information downloaded from a server 1900. The server system 1900 runs server software 1914, including the inventory loading software 1916 of the present invention, which interacts with the toothbrush/charging station/mobile device 1924 and a user information database 1902. The database 1902 contains contact information entered by registered users. The language processing software 1916 in some situations will process a user's verbal commands by acting in means including but not limited to pulling information from the database 1902 adding information to it, sending information back to the device such it can respond verbally to the user in language they will understand. Both the server 1900 and the docking station/mobile device 1924 include respective storage devices, such as hard disks 1906 and 1934 and operate under the control of operating systems 1918, 1932 executed in RAM 1912, 1928 by the CPUs 1904, 1940. The server storage device 1906 stores program files 1908 and the operating system 110. Similarly, the user storage devices 134 store the inter/intranet browser software 1936 and the operating systems 1938. In some embodiments, the user would utilize the inventory location software/user interface 1942 on their mobile device 1924. In some such embodiments this system may involve an application which may process a variety of functions including but not limited to vocal commands, language translation, responses, ordering of replacement parts, scheduling dentist appointments, or letting a user know how well they or any family members in their home network database or in competition with them on a cloud database are performing functions including but not limited to cleaning their teeth or replacing their brush components.

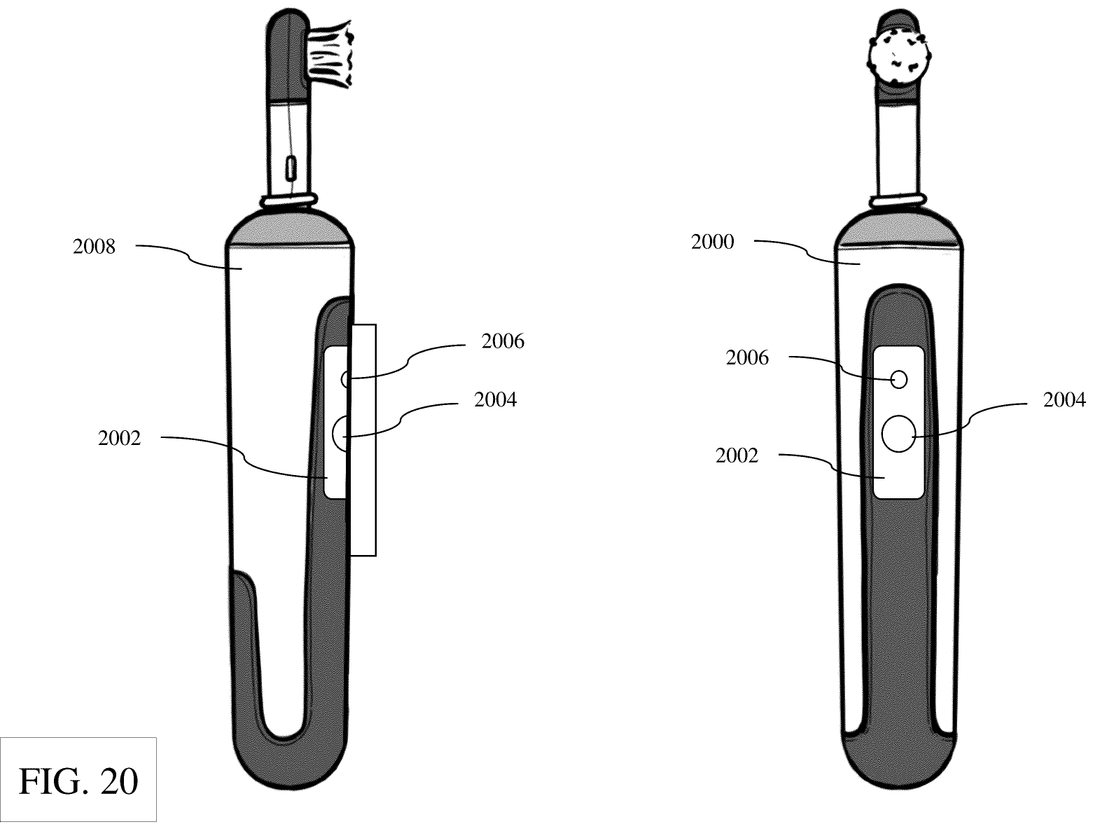

FIG. 20 is a 2000 front and 2008 side representation of an oral device regulated by an oscillation mechanism, with sensor mounting faceplate 2002, on which sensors such as cameras 2004 or flash devices 2006 may be mounted. In some such embodiments an electric toothbrush may detect motion utilizing sensors including but not limited to cameras or IMUs on the brush, which can activate the brush or triggers a specific oscillation motion.

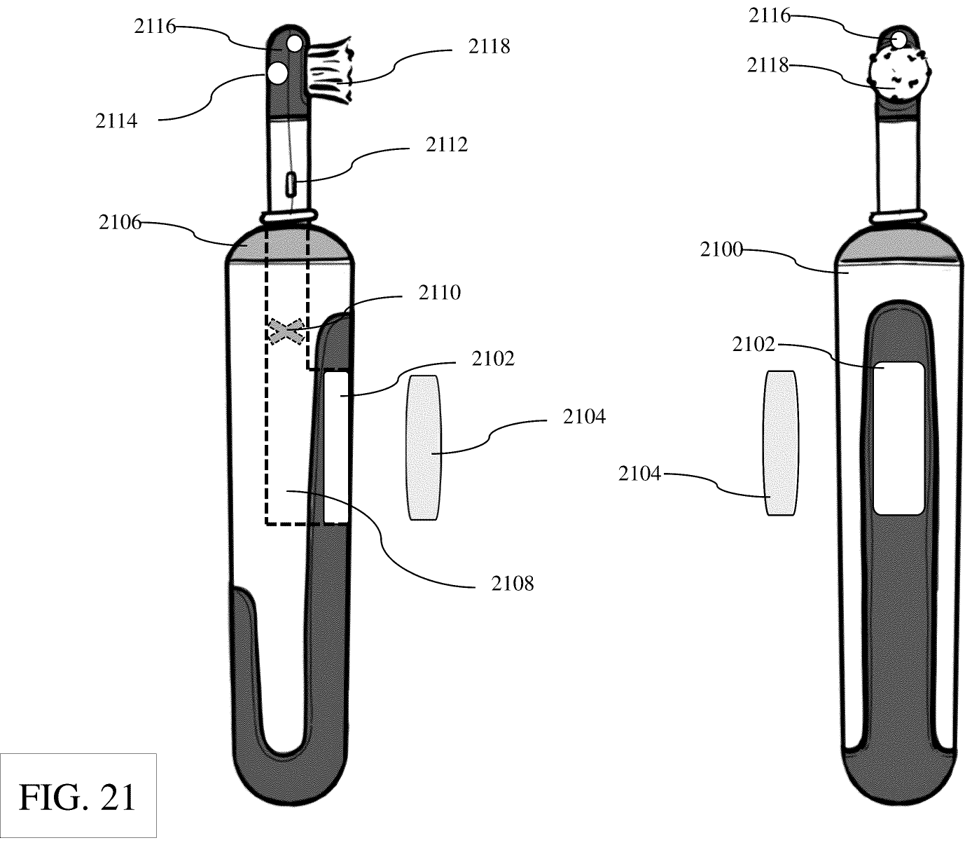

FIG. 21 is a front 2100 and side (cross-sectional) 2106 exemplary embodiment of an oral device regulated by an oscillation mechanism, where toothpaste cartridges 2104 may be inserted through an orifice 2102, then fed up towards the motorized brush 2118, in some such embodiments passing through a grinder 2110 and liquid syphon or filter 2112. In some such embodiments an electric toothbrush may utilize sensors including but not limited to thermocouples 2114, pressure sensors, blood sensors (with the ability to detect bleeding gums), glucose sensors, biomarker sensors or IMUs 2118 on the brush-head.

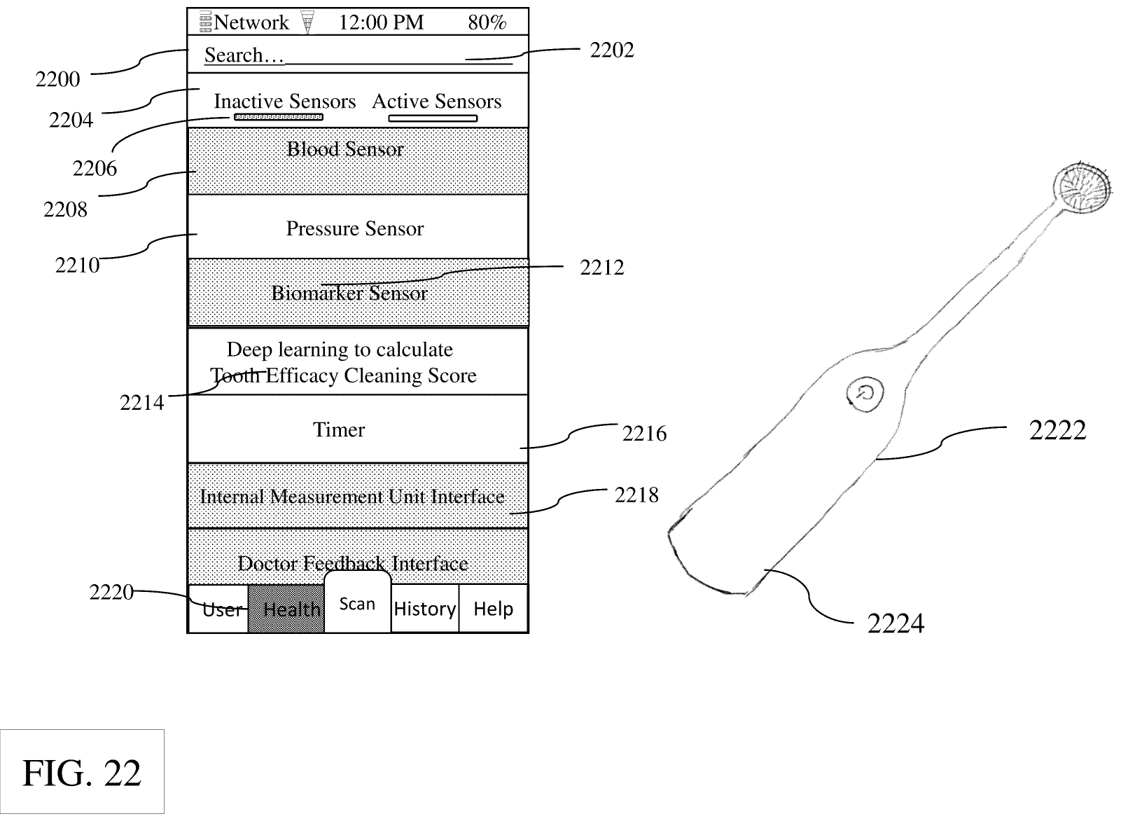

FIG. 22 is an exemplary embodiment of a motorized toothbrush 2222, fitted with one or more sensors 2224, one or more of which may interface with and/or be controlled by a GUI interface 2200 which may allow a user to search for additional sensors to add, highlight 2206 and/or allow a user to select which sensors are active or inactive 2204. In some embodiments a user may be able to see if certain sensors are active and/or connect them, including but not limited a blood sensor 2208 which may detect how much a user's gums are bleeding, pressure sensor 2210 to detect how hard a user is brushing, a biomarker sensor 2212 to detect the presence of certain biomarkers which may indicate a change in calibration or the onset of certain health issues, certain higher functions such as a deep learning algorithm to calculate a user's TEC score 2214, a timer 2216 to determine how long a user has been brushing, an IMU interface 2218 and a doctor feedback interface. In this exemplary embodiment there are also options to change the menu on the GUI as the mode 2220 Health is currently selected in the illustration.

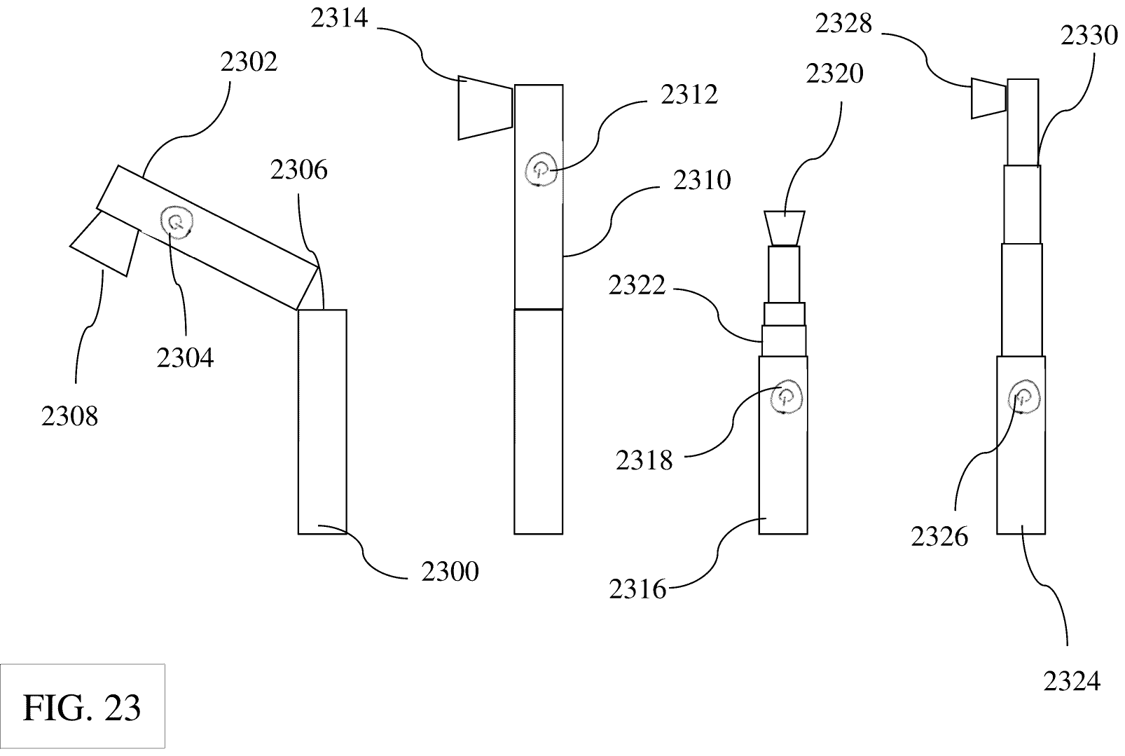

FIG. 23 is a side representation of an oral device—in this case a travel, take-to-work, electric tooth-brush 2300, 2316, 2310, 2324 which includes a compact design, which may be compressible by means including but not limited to a foldable joint 2306 or a telescoping design 2322, such that it could more easily fit into a small compartment. Some embodiments may include but are not limited to features such as a button 2304, 2312, 2318, 2326 to activate the motorized brush 2308, 2314, 2320, 2328 folding ability 2302, 2310 or telescoping ability 2330.

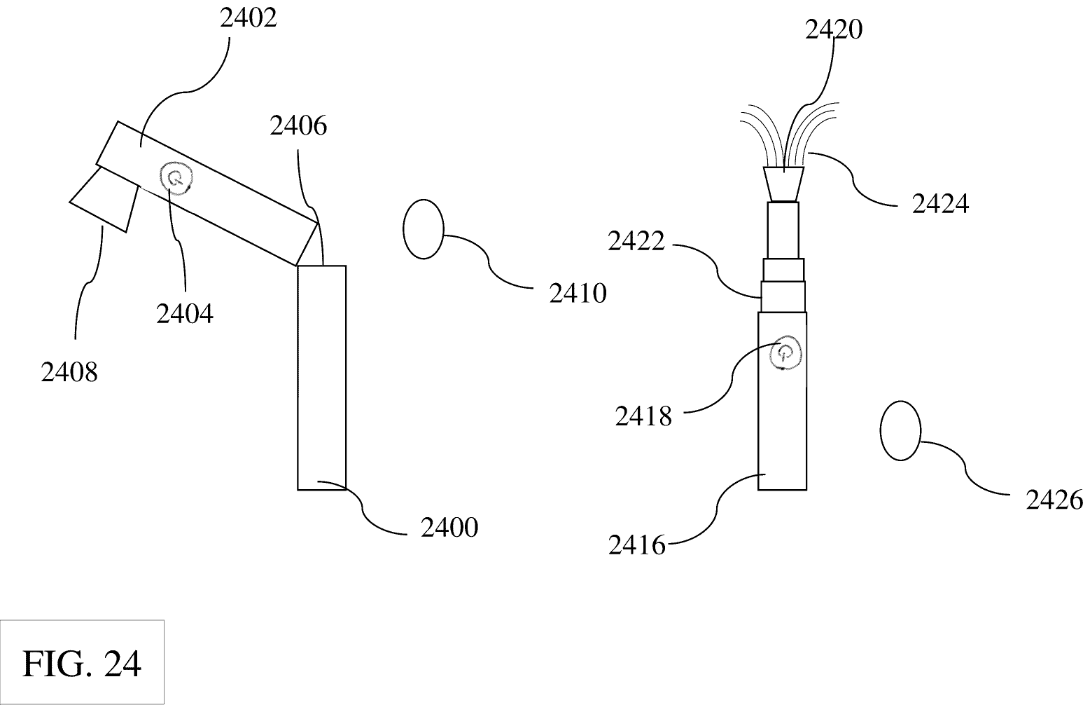

FIG. 24 is a side representation of an oral device - in this case a travel, take-to-work, electric tooth-brush, 2400, 2416 which includes a compact design, which may be compressible by means including but not limited to a foldable joint 2406 or a telescoping design, 2422 such that it could more easily fit into a small compartment, and further contains an orifice 2406, 2416 for inserting one or more toothpaste cartridges 2410, 2426, which may release liquid 2424 from the brush head 2420, 2408, while the motorized brush is activated by depressing the on button 2404, 2418 for cleaner more efficient brushing.

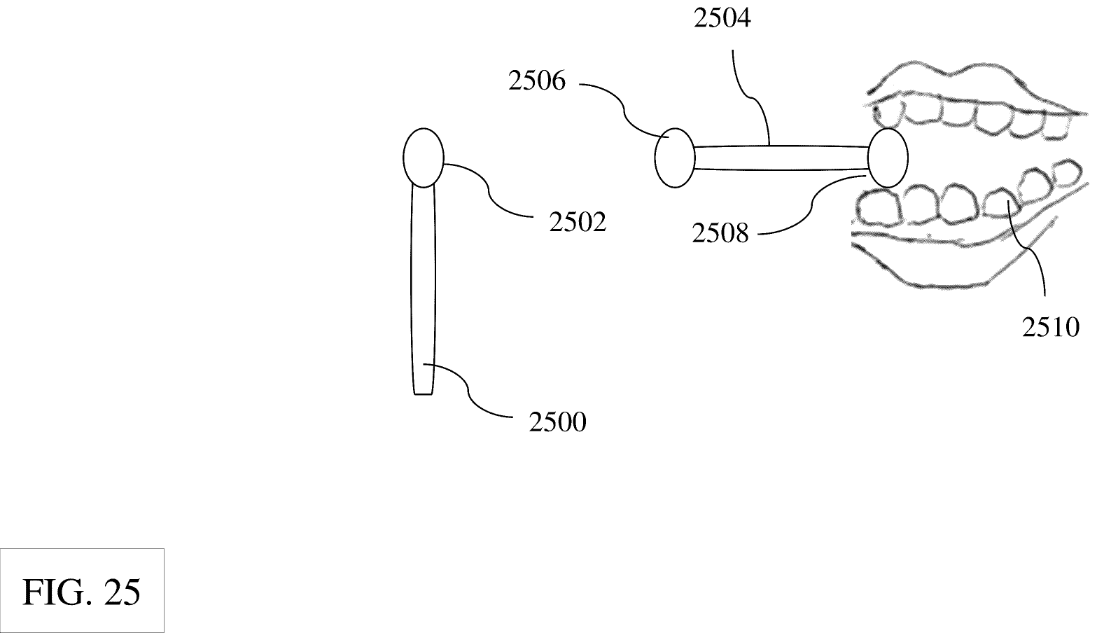

FIG. 25 is a drawing of a q-tip style toothbrush 2500, 2504 were one or more ends 2502, 2506, 2508 may be fitted with a toothpaste cartridge or gel, which may turn to a liquid or paste once bitten or inserted in a user's mouth 2510.

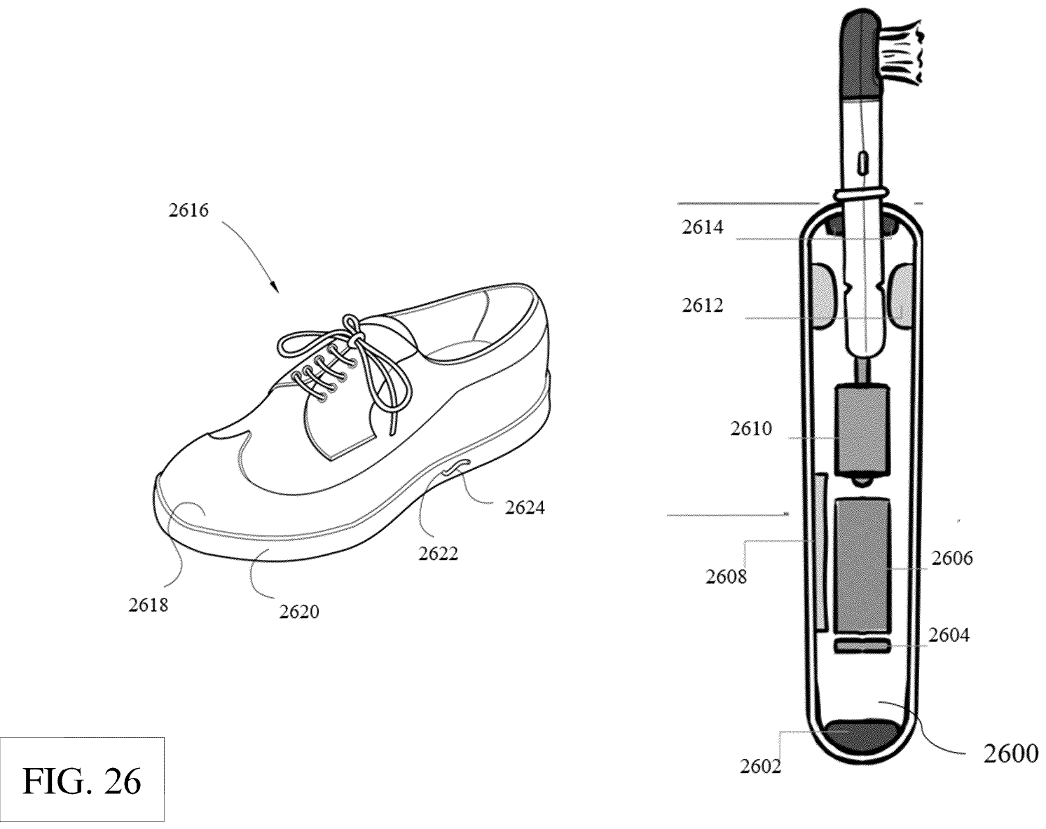

FIG. 26 is an orthogonal and a cross sectional representation of a sensor driven shoe 2616 and an oral device 2600 both respectively fitted with health monitoring sensors including but not limited to IMUs, dampeners, Bluetooth and various other features. The toothbrush 2600 may be outfitted with sensors including but not limited to IMUs 2602, Bluetooth components 2604 for communication, a battery 2606 for powering the device, a charging module 2608 for charging the device, an oscillator 2610 for regulating the motion of the stem, dampers 2612 for reducing the force placed on the stem, or additional sensors related to the movement of the brush head 2614. The shoe 2616 may include additional sensors such as an IMU 2618, pressure sensor 2620, gyroscope 2622 and/or wireless connectivity 2624.

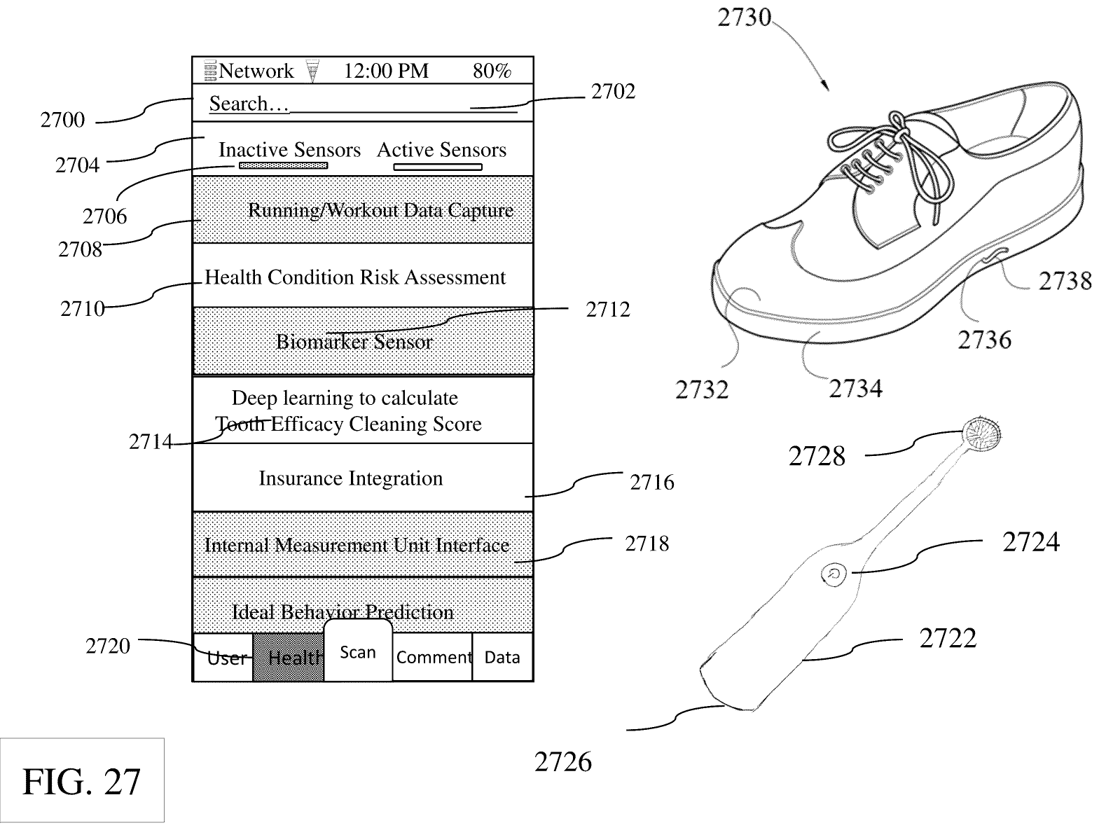

FIG. 27 is an embodiment of a motorized toothbrush 2722, fitted with one or more sensors 2724, one or more of which may interface with and/or be controlled by a GUI interface 2700 which may allow a user to search for additional sensors to add, highlight 2706 and/or allow a user to select which sensors are active or inactive 2704. In some embodiments a user may be able to see if certain sensors are active and/or connect them, including but not limited a running or workout data capture sensor 2708 which may detect how a user is moving based on their clothing movement (in this case a shoe), a health condition risk assessment sensor 2710 to detect any risk based on the user or asset health, a biomarker sensor 2712 to detect the presence of certain biomarkers which may indicate a change in calibration or the onset of certain health issues, certain higher functions such as a deep learning algorithm to calculate a user's TEC score 2714, integration with the user's insurance 2716 to determine whether or not the user is eligible for new/replacement products through their insurance, an IMU interface 2718 and an ideal behavior prediction interface. In this exemplary embodiment there are also options to change the menu on the GUI as the mode 2720 Health is currently selected in the illustration. Orthogonal representations of a sensor driven shoe 2730 are provided with health IMUs 2732, dampeners 2734, Bluetooth 2736 and various other features 2738, which may interface with and/or be controlled by a health-related GUI interface.

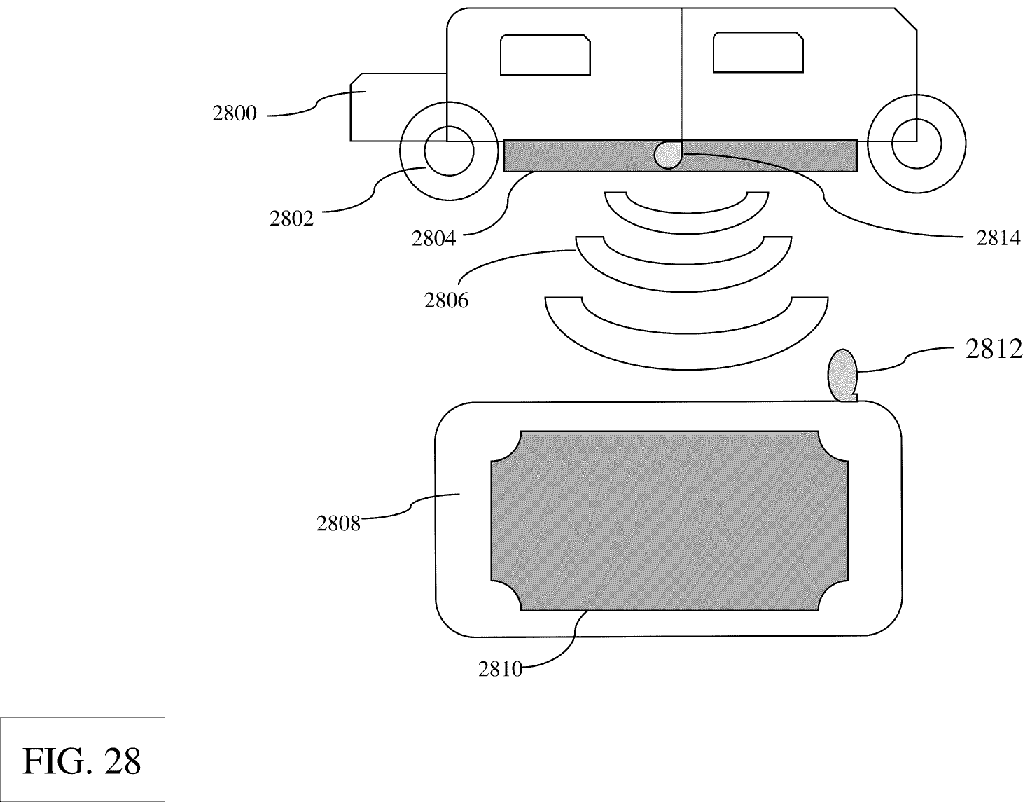

FIG. 28 is a drawing of a vehicle 2800 with a battery docking station 2804 located between an electric vehicle's tires 2802, transmitting a signal 2806 for battery placement between a sensor 2814 located on the docking station and a sensor 2812 located in a battery replacement facility 2808, said battery replacement facility further comprising one or more replacement batteries 2810.

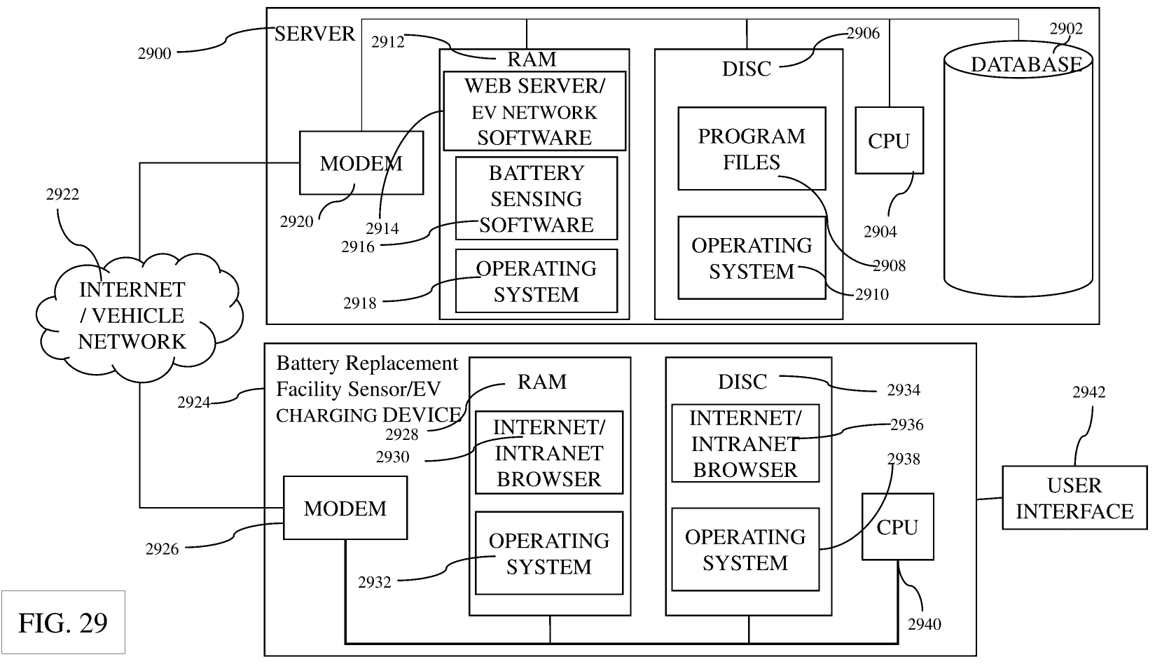

FIG. 29 is an embodiment following a standard Internet architecture in which one or more user's Battery Replacement Facility Sensor/EV Charging Device 2924 and a server 2900 are connected via the internet/vehicle network 2922 and modems 2926, 2920 or other communications channels. A user accesses the server 2900 via their Battery Replacement Facility Sensor/EV Charging Device 2924 potentially in response to battery sensed data detected and processed via a web browser 2930 or other software application residing in RAM memory 2928 that allows it to display information downloaded from a server 2900. The server system 2900 runs web server/EV network software 2914, including battery sensing software 2916 of the present invention, which interacts with the Battery Replacement Facility Sensor/EV Charging Device 2924 and a vehicle information database 2902. The database 2902 contains vehicle information entered autonomously or by one or more users. The battery sensing software 2916 in some situations will process battery sensed data by acting in means including but not limited to pulling information from the database 2902 adding information to it, sending information back to the device such it can respond inform the user in language they will understand. Both the server 2900 and the Battery Replacement Facility Sensor/EV Charging Device 2924 include respective storage devices, such as hard discs or optical discs 2906 and 2934 and operate under the control of operating systems 2918, 2932 executed in RAM 2912, 2928 by the CPUs 2904, 2940. The server storage device 2906 stores program files 2908 and the operating system 2918. Similarly, the electric vehicle RAM 2928 stores the inter/intranet browser software 2930 and the operating systems 2932. In some embodiments the user would utilize the user interface 2942 on their electric vehicle 2924. In some such embodiments this system may involve an application which may process a variety of functions including but not limited to vocal commands, language translation, responses, locating of replacement batteries, guiding an automated service device and transmitting information with a battery service or replacement facility regarding the amount of charge left in a battery.

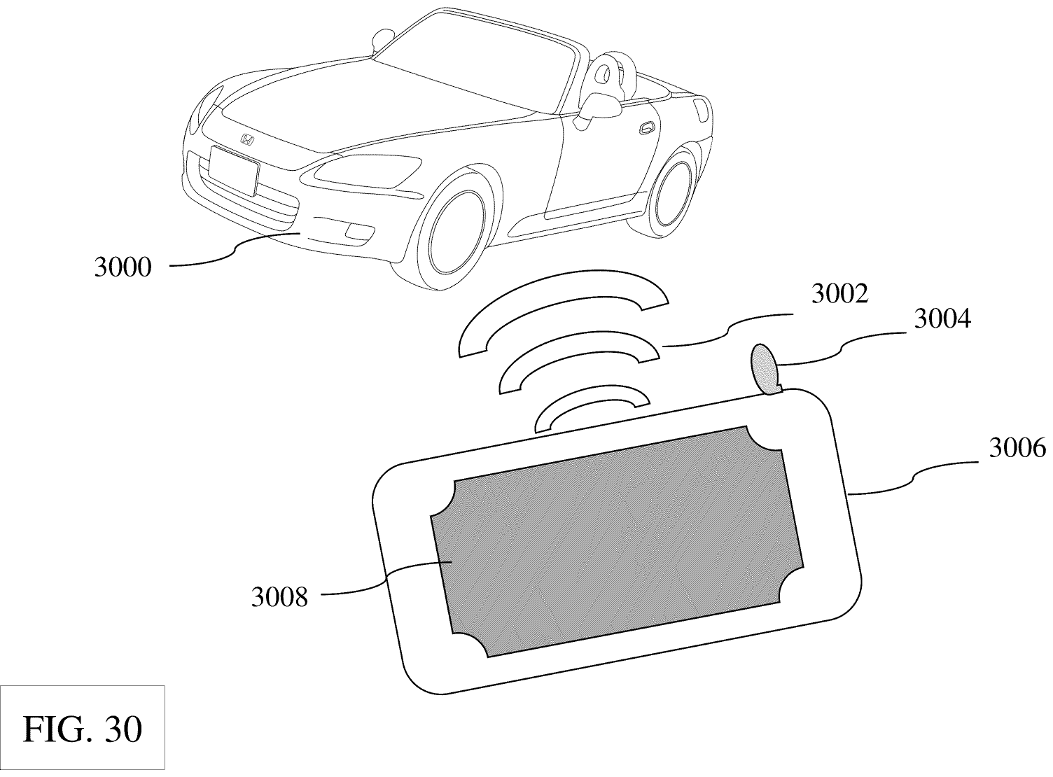

FIG. 30 illustrates a line drawing of a battery replacement or servicing facility 3006 which senses a battery in a nearby device, in this case an electric car 3000, which it can transmit information 3002 between from a sensor 3004 to allow for servicing or replacement as needed using one or more contained batteries 3008.

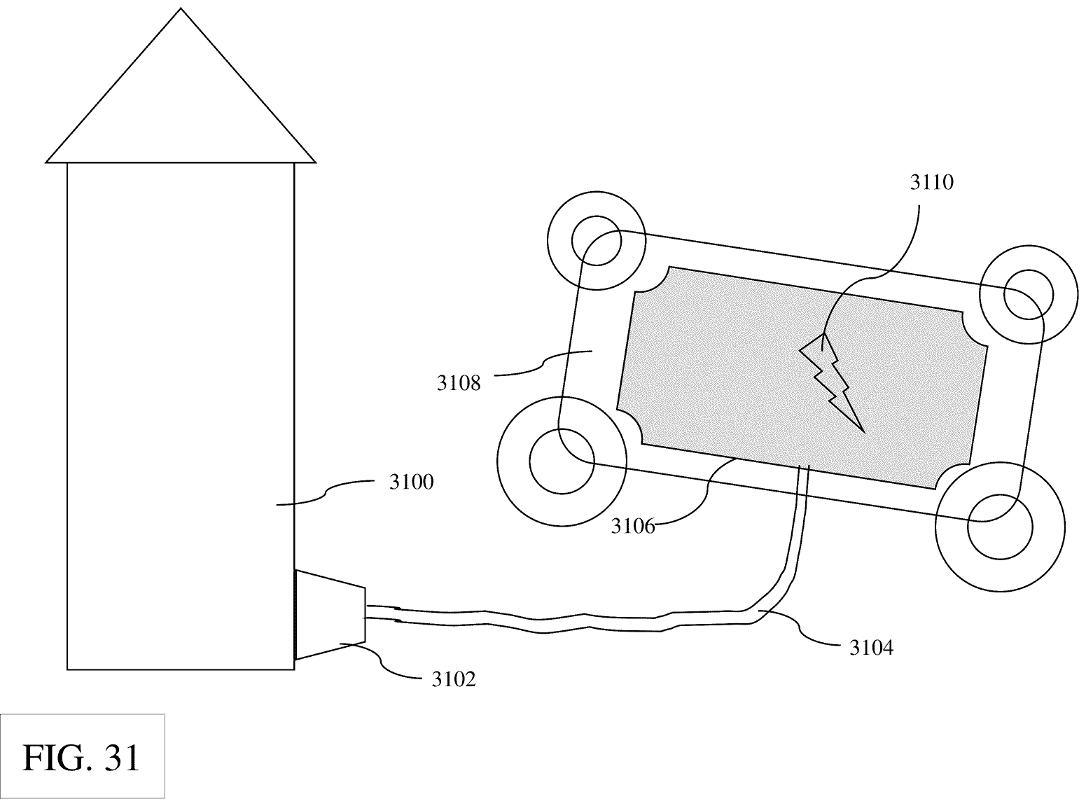

FIG. 31 is a drawing of a building 3100 being used to charge 3110 a replaceable vehicle battery 3106 using a bi-directional Alternating Current adapter 3102 which can also be used to send energy from the electric vehicle 3108 via one or more cables 3104 replacement battery to the house in the event of a power outage.

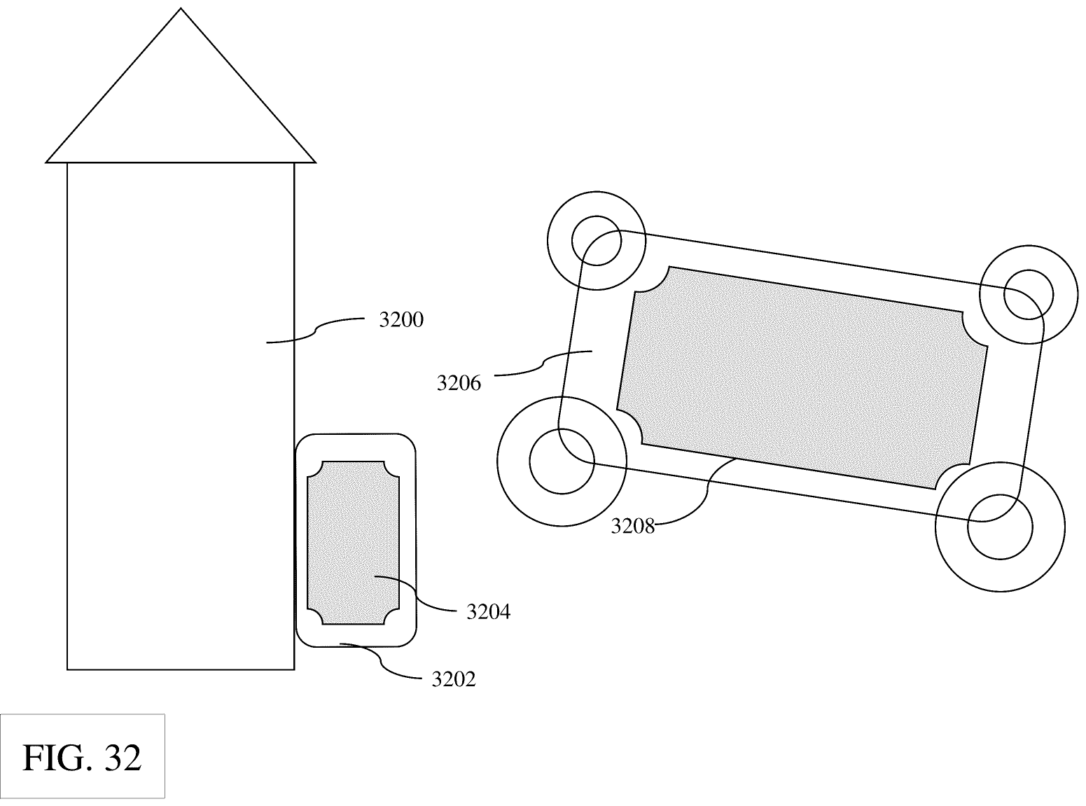

FIG. 32 is a drawing of a building 3200 with a replacement battery docking station 3202 allowing for collection of energy from a docked battery 3204 in the form of reserve power for the house in case of an outage, or replacement of a vehicle's 3206 battery 3208 and swapping with and charging of a vehicle battery in need of charging.

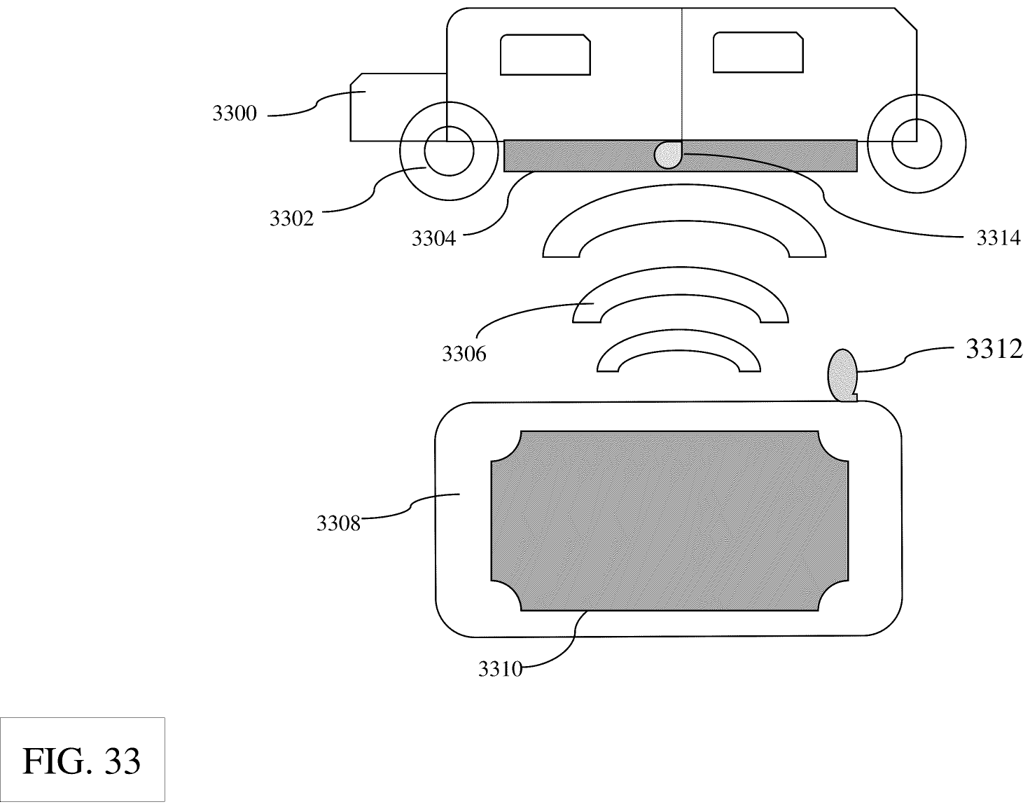

FIG. 33 is a drawing of a vehicle 3300 with a battery docking station 3304 located between an electric vehicle's tires 3302, receiving a signal 3306 for battery placement to a sensor 3314 located on the docking station from a sensor 3312 located in a battery replacement facility 3308, said battery replacement facility further comprising one or more replacement batteries 3310.

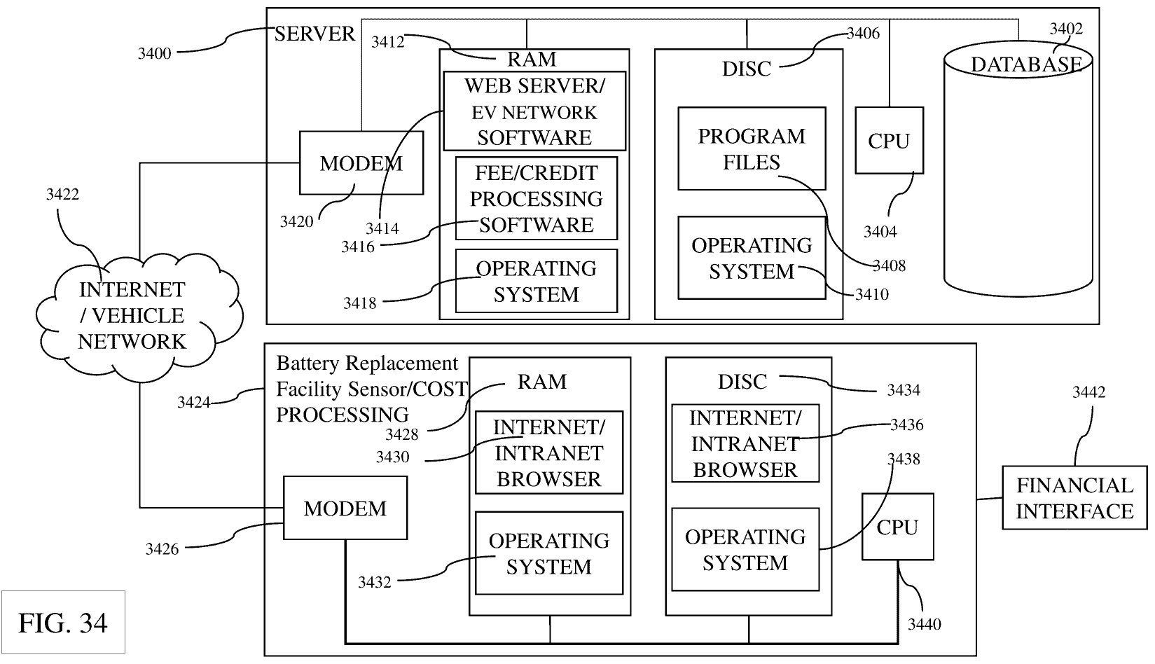

FIG. 34 is an embodiment following a standard Internet architecture in which one or more user's Battery Replacement Facility Sensor/Cost Processing Devices 3424 and a server 3400 are connected via the internet/vehicle network 3422 and modems 3426, 3420 or other communications channels. Access is made to the server 3400 via the Battery Replacement Facility Sensor/Cost Processing Device 3424 potentially in response to battery sensed data detected and processed via a web browser 3430 or other software application residing in RAM memory 3428 that allows it to display information downloaded from a server 3400. The server system 3400 runs web server/EV network software 3414, including fee/credit processing software 3416 of the present invention, which interacts with the Battery Replacement Facility Sensor/Cost Processing 3424 and a battery information database 3402. The database 3402 contains battery and credit information entered autonomously or by one or more users. The fee/credit processing software 3416 in some situations will process battery sensed data by acting in means including but not limited to pulling information from the database 3402 adding information to it, sending information back to the device such it can respond inform the user in language they will understand. Both the server 3400 and the Battery Replacement Facility Sensor/Cost Processing Device 3424 include respective storage devices, such as hard discs or optical discs 3406 and 3434 and operate under the control of operating systems 3418, 3432 executed in RAM 3412, 3428 by the CPUs 3404, 3440. The server storage device 3406 stores program files 3408 and the operating system 3418. Similarly, the electric vehicle RAM 3428 stores the inter/intranet browser software 3430 and the operating systems 3432. In some embodiments the user would utilize the financial interface 3442 on their electric vehicle or cost processing device 3424. In some such embodiments this system may involve an application which may process a variety of functions including but not limited to information regarding cost processing which may process a variety of functions including but not limited to fee or credit processing, utilizing the electric vehicle or the battery replacement facility's network or the internet, and may operate a financial interface for charging a vehicle owner, user or an automated account.

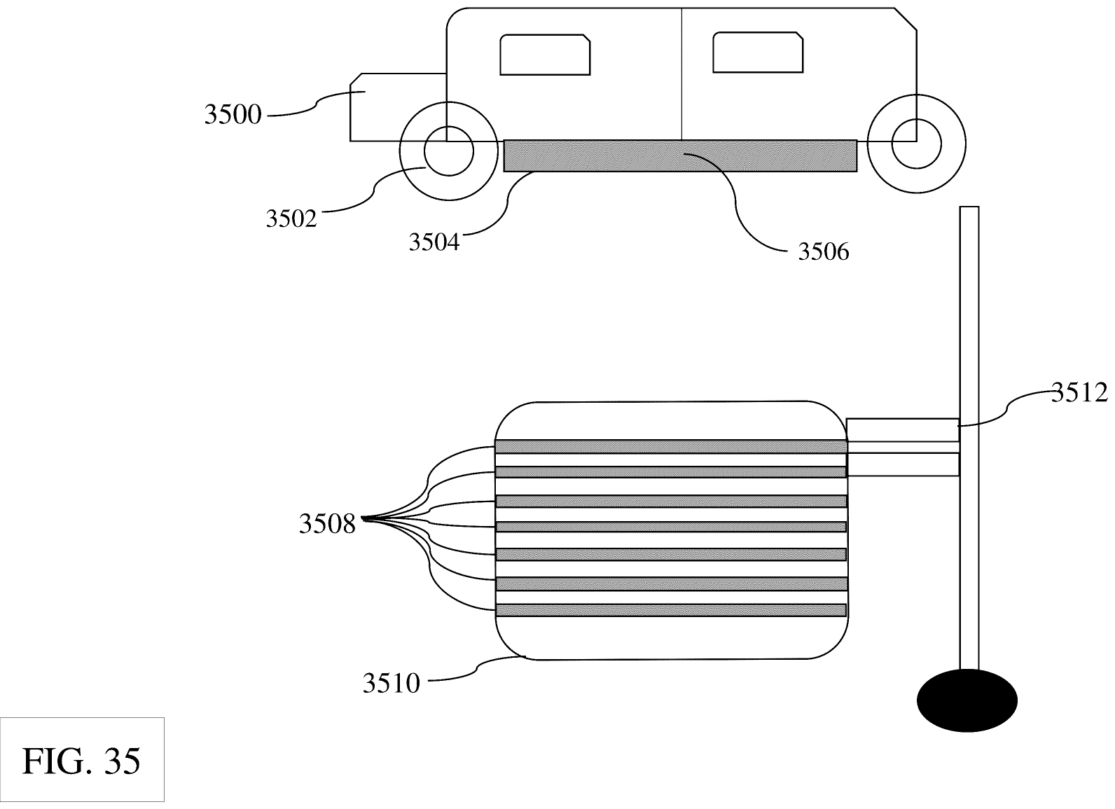

FIG. 35 is a side view of a vehicle 3500 with a battery docking station 3504 located between the vehicle's tires 3502, said docking station further comprising one or more rectangular batteries 3506 with the battery replacement or servicing facility further comprising a storage container 3510, in this case being located underground, for storing one or more replacement batteries 3508, and further comprising one or more automated servicing devices 3512 for removing batteries from the vehicle's docking station for charging and replacing batteries with one of the batteries located in the storage container. In this embodiment the automated servicing device is an arm that clamps down on the vehicle battery to remove it and place it in the storage container, then clamps down on the replacement battery and moves it into position within the vehicle docking station

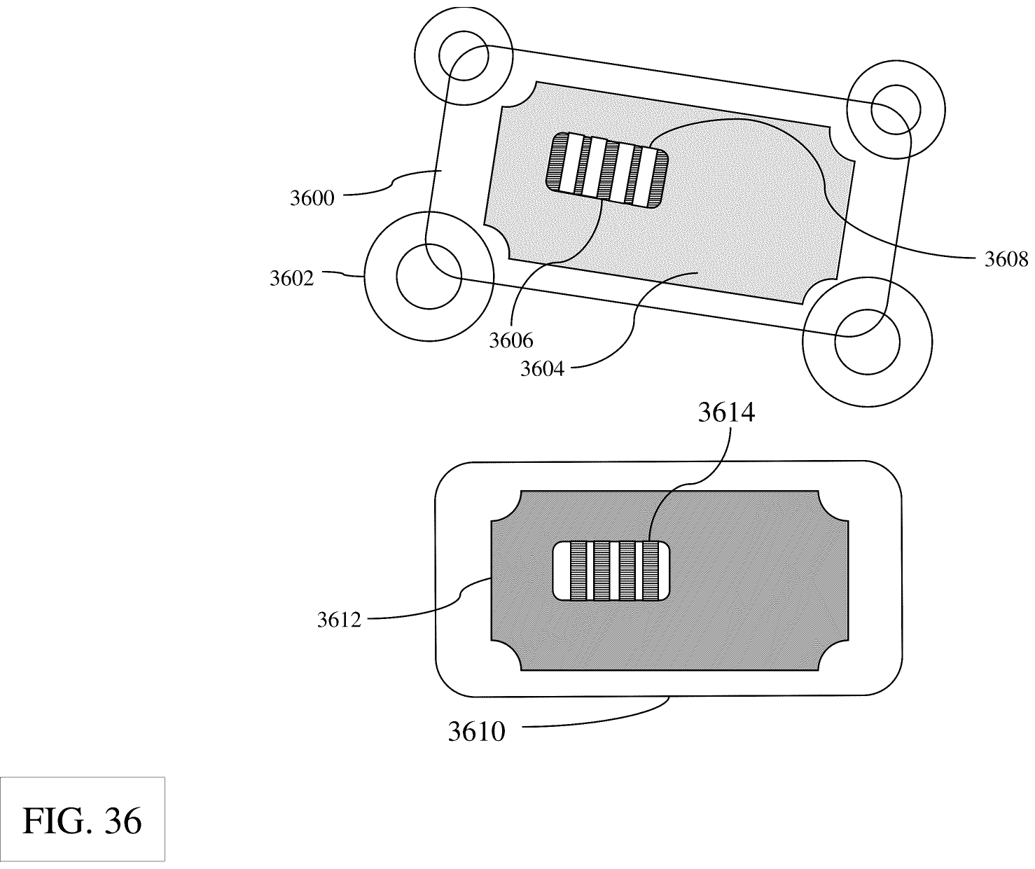

FIG. 36 is a cross sectional view showing a battery docking station 3604 located between an electric vehicle's tires 3602, said docking station further comprising a docking port 3606 for connecting with and allowing the transfer of energy from a rechargeable battery which may be synced with said electric vehicle 3600, said rechargeable battery 3612 further comprising an interfacing port 3614 with which to transfer energy to said electric vehicle, or absorb energy from a charging port at a charging location including but not limited to a battery replacement or servicing facility or a battery docking station. In some such embodiments the grooves of the battery interfacing port may fit within the openings 3608 of the docking station's docking port.

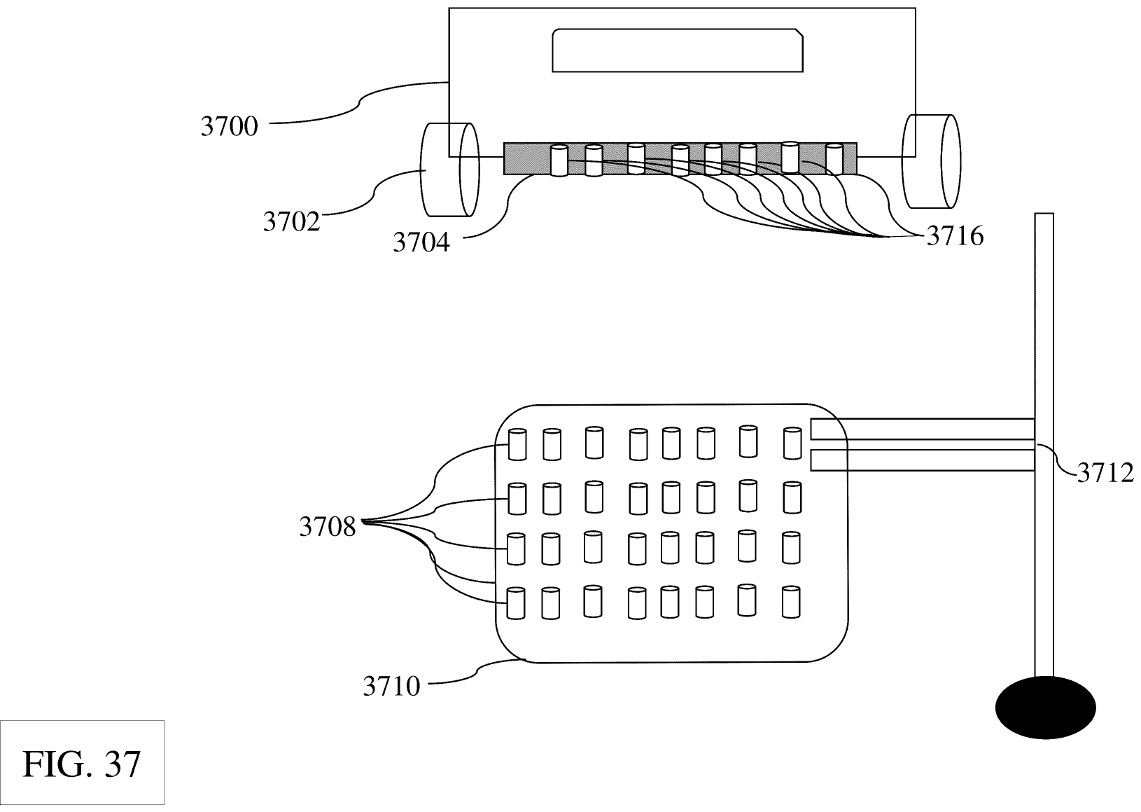

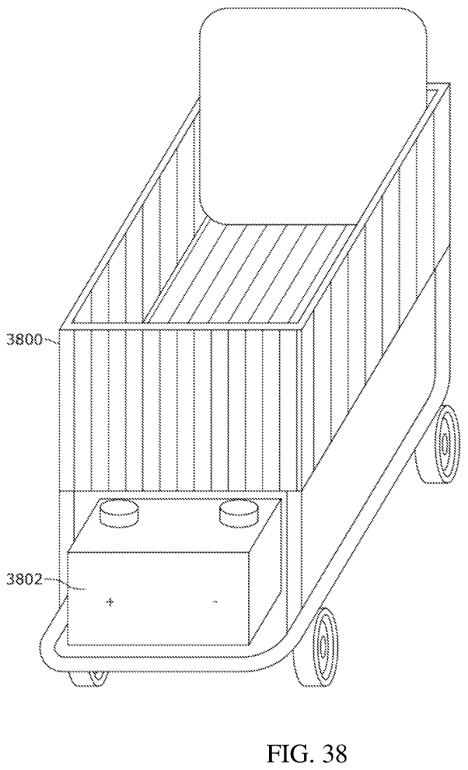

FIG. 37 is a side view of a vehicle 3700 with a battery docking station 3704 located between the vehicle's tires 3702, said docking station further comprising one or more non-rectangular batteries 3706 with the battery replacement or servicing facility further comprising a storage container 3710, in this case being located underground, for storing one or more rows of non-replacement batteries 3708, and further comprising one or more automated servicing devices 3712 for removing batteries from the vehicle's docking station for charging and replacing batteries with one of the batteries located in the storage container. In this embodiment the automated servicing device is an arm that clamps down on the vehicle battery to remove it and place it in the storage container, then clamps down on the replacement battery and moves it into position within the vehicle docking station. In some of these embodiments the station may be capable of measuring the remaining charge in the one or more replaced batteries and the amount of charge in the one or more replacement batteries and prorating the fee accordingly. An embodiment of the present disclosure is displayed in FIG. 38, which provides an illustration of a transportation device with a battery mounted to it for the storage of energy. A transportation device 3800 (including but not limited to an electric vehicle or shopping cart), is affixed with a battery 3802, which may be fed by mechanisms including but not limited to a flywheel, solar energy, a charging station or may itself be synergistic so as to feed energy to the device, it's docking station or a tethered device.

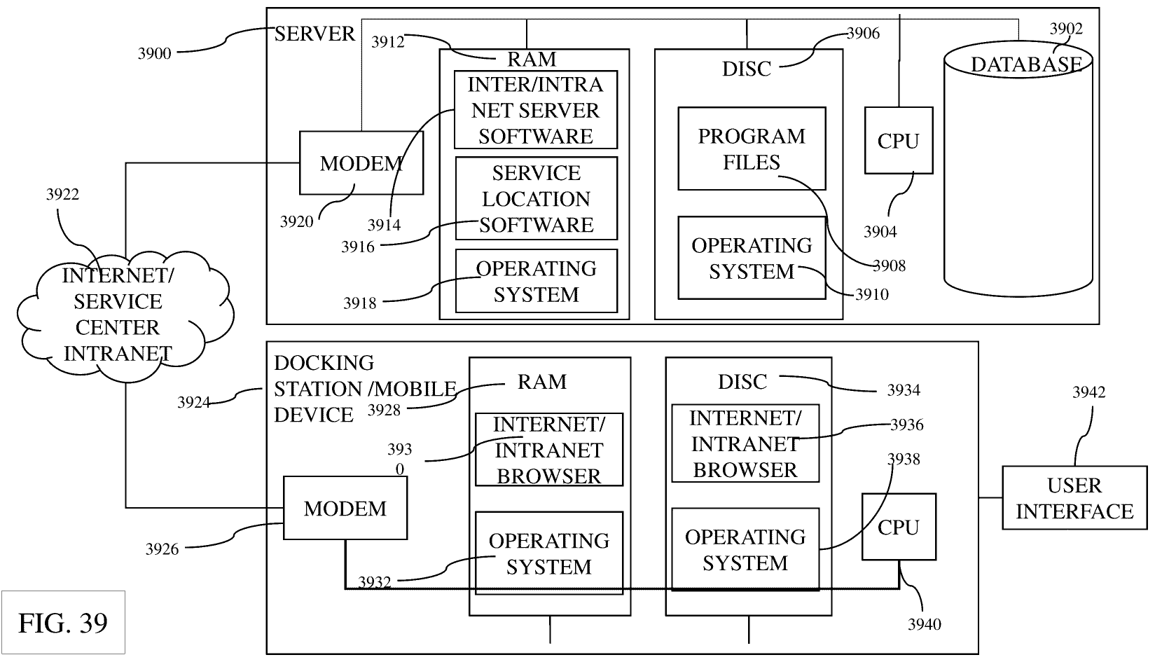

FIG. 39 is an embodiment following a standard Internet architecture in which user docking station/mobile device 3924 and a server 3900 are connected via the internet/service center or battery replacement center intranet 3922 and modems 3926, 3920 or other communications channels. A user accesses the server 3900 via their docking station/mobile device or other vehicle user interface 3924 operating a web browser 3930 or other software application residing in RAM memory 3908 that allows it to display information downloaded from a server 3900. The server system 3900 runs server software 3914, including the service location software 3916 of the present invention, which interacts with the docking station/mobile device 3924 and a user information database 3902. The database 3902 contains contact information entered by registered users. The service center location software 3116 in some situations will notify any number of users of updates made to the database 3902 regarding the availability of or updates to service including but not limited to vehicles, charging stations or batteries. Both the server 3900 and the docking station/mobile device 3924 include respective storage devices, such as hard disks 3906 and 3934 and operate under the control of operating systems 3918, 3932 executed in RAM 3912, 3928 by the CPUs 3904, 3940. The server storage device 3906 stores program files 3908 and the operating system 3110. Similarly, the user storage devices 3134 store the inter/intranet browser software 3936 and the operating systems 3938. In some embodiments, the user would utilize the service center location software/user interface 3942 on their mobile device to direct one or more vehicles 3924.

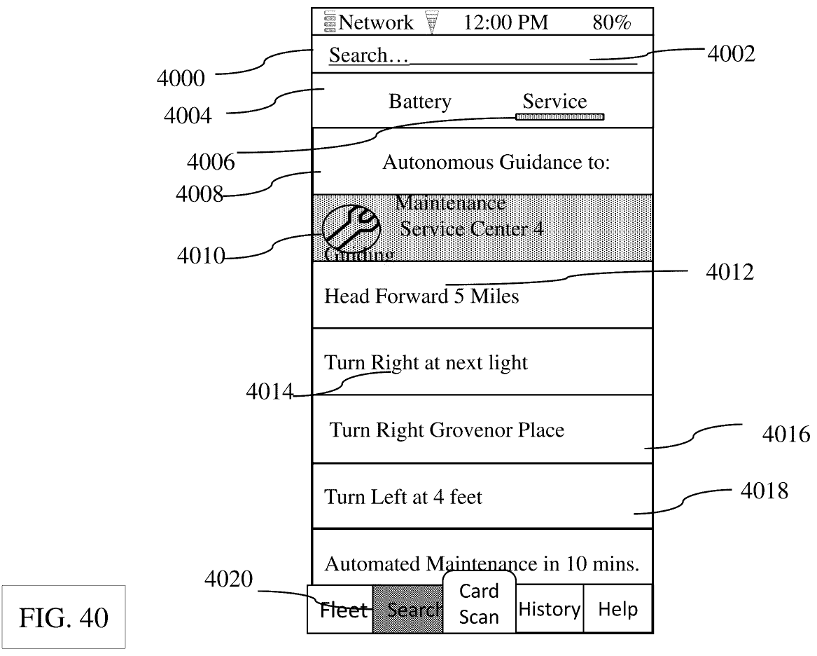

Yet another embodiment of the disclosure is illustrated in FIG. 40. An app. 4000, further comprising a search bar 4002, an option to select Battery or Service 4004, a highlighted underlining to show which submenu is selected 4006, an option to select Autonomous Guidance mode 4008 (an alternate option to Manual or Semi-Autonomous driving), a highlighted picture 4010 and description of the selected service 4010 to show it is selected, turn by turn navigation directions 4012, 4014, 4018 and a highlighted button showing which menu is selected 4020 is used to illustrate the interface which a user may utilize to search for and locate service centers in conjunction with the transportation device of this disclosure.

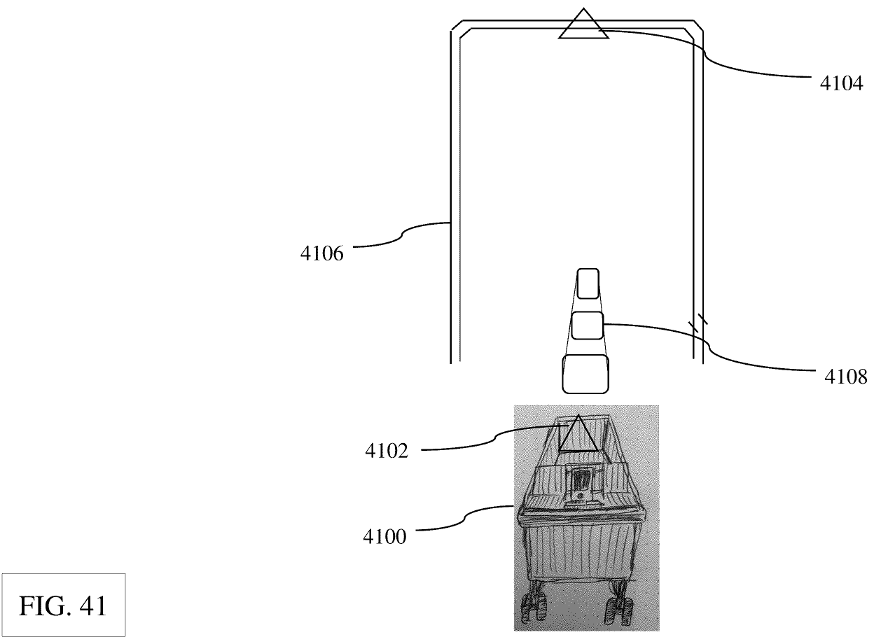

FIG. 41 depicts an additional embodiment, in which an autonomous vehicle (in this image a cart) 4100 with a master-scanner transmitter 4102 that sends signals to a master-scanner receiver 4104 indicating whether any inventory in the cart has yet to be accounted for as the cart passes through the master-scanner 4106. In some such embodiments the cart may pass through the master-scanner without the aid of human propulsion, including but not limited to autonomous movement or a conveyance system 4108.

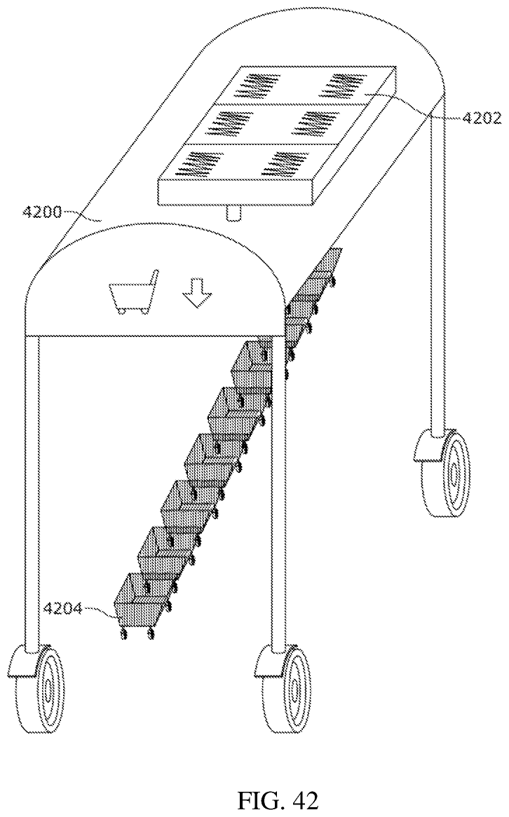

Yet another embodiment of this disclosure is displayed in FIG. 42, wherein a docking station 4200, further comprising solar panels 4202, which are used to charge docked vehicles, electric vehicles or intelligent carts 4204, either directly through wired mechanisms or through a battery. In some such embodiments docked carts may charge through electrical brushes connected directly to the cart's adjacent battery. In other such embodiments empty carts which are left in idle may autonomously return to said docking station utilizing reserve battery power. In yet other embodiments, users may request a cart using a phone app which syncs to the docking station via mechanisms including but not limited to Bluetooth or Wi-Fi. The cart at the front of the docking station, being the least recently docked cart, would be discharged for the users use, in order to ensure somewhat equalized usage time for such electric vehicles, carts in order to reduce premature failures due to life-cycle wear and tear as opposed to infant mortality or random failures of the carts.

In some embodiments of the present disclosure companion software capable of accessing data and adding comments, and quantitative evaluations through GUI may be integrated.

In other embodiments capturing running data, workout data, health data, dental data, joining it with insurance data to predict ideal health behavior and/or risk for certain conditions is part of the design of the system.

Some embodiments of the present disclosure may involve apparatus, methods, or systems for machine learning comprising sensors including but not limited to weight, pressure, battery life measurement or magnetic field sensors, which transmit data to one or more computers which may perform functions including but not limited to interfacing with the internet or a network of similar computer devices, comparing and contrasting past data from the one or more sensors, or make assessments based on internal data prerecorded or uploaded via direct means such as USB or other physical media, to determine, learn and/or make adjustments including but not limited to the type of object that has been placed on it, the ideal magnetic field to apply, the adjustments to charging that should be made to optimally support battery life, the amount of pressure to apply for brushing based on a particular users past practices where the apparatus is a brush with a magnetic field, how to spot diseases such as those involving tooth decay or particular issues such as imbalance in a vehicle based on the angle it levitates at, or what angle to spin an object in based on sensory information including but not limited to applause data, the location of the audience or the particular object being levitated. In some such embodiments a force dampening mechanism may be incorporated, or additional sensory feedback can be applied including but not limited to visual (such as lights or displayed data), audio (such as beeps or the device making statements or sending signals to another device to make statements to the user), or tactile (such as vibrating or gyroscopic disengagement), to notify one or more users or provide feedback related to a force dampened toothbrush which may utilize such a pad.

Additional embodiments include but are not limited to the following: An apparatus comprising: an electromagnetic surface and/or an object holder with a magnetic face facing resting on the electromagnetic surface with an opposite charge. Such an apparatus further comprising a magnetic field mechanism adjuster with: an adjustable timer, a response mechanism that activates or deactivates the electromagnetic surface in response to the countdown of the timer, an application interface to remotely control the timer, one or more concentric surfaces with varying electromagnetic charges that may adjust the angle of any opposing magnetic object, with a charging pad embedded in the electromagnetic surface, an adjustable mechanism that allows a user to adjust the desired percent charged, a response mechanism that activates or deactivates the electromagnetic surface in response to the percent the object is charged. An alternative is an apparatus such as those described above further comprising: an apparatus interface to remotely adjust the desired percent charged prior to the electromagnetic surface activation and object levitation. Another alternative is an apparatus described in above further comprising one or more motors which cause the electromagnetic surface to rotate such that any levitated object will spin in response. Another alternative is an apparatus as described above further comprising, a plurality of electromagnetic surfaces, a field adjustment mechanism and one or more motors, gears or pulleys.

Even more additional embodiments include but are not limited to the following: A method comprising: measuring the health of one or more batteries attached to a powered asset; signaling, by one or more computing devices the status of the health of the battery, location of the nearest facility or signaling to an automated replacement facility a notification that causes the battery to be removed for service and either serviced while attached to the asset or removed for servicing and replaced. An alternative is a method as described above, wherein the battery is attached to a vehicle and removed by an automated drone when it is detected that the battery needs servicing. Another alternative is the method as described above, wherein the battery is embedded into a smart-shirt and maintenance includes an automated spray of perfume when perspiration is detected above a preset level. Another alternative is the method as described above, wherein the battery is attached to the base of the vehicle and a signal is transmitted between the vehicle and nearby battery maintenance facilities; the vehicle then drives autonomously or semi-autonomously to one such maintenance facility if the battery is in need of maintenance or recharging; the battery is serviced, charged or replaced, and the vehicle receives a signal to leave the facility accordingly. Methods where predictive measures to reduce the failure of batteries and associated devices are included as well.

Additional embodiments include but are not limited to the following: A system for charging or levitating an object, said system further comprising: one or more batteries; a docking station for one or more of said batteries; an alternating current adapter plug for said docking station. An alternative is system as described above, further comprising one or more electromagnetic surfaces and one or more objects, wherein one or more of said magnetic surfaces is a charging pad, and one or more electromagnetic surfaces does not become active until a desired function is achieved, said function being: a user defined charging time has passed, or a user defined charging percent has been achieved. Another alternative is a system such as the one described above wherein at least one of said objects is a portable device, including but not limited to a cell-phone or laptop, an electric oral health device including but not limited to a toothbrush or scrolling flosser, an electric razor, an electric vehicle including but not limited to an autonomous car, a driven car or a semi-autonomous car, a cart, or clothing including but not limited to a smart shirt or a shoe comprising one or more sensors. Another alternative is a system such as the ones described above, wherein said docking station is mounted to the underbelly of an electric vehicle, said electric vehicle using the one or more rechargeable batteries for electric power. Another alternative is a system such as the ones described above wherein said docking station further comprises an alternating current adaptable plug for recharging said one or more rechargeable batteries. Another alternative is a system such as the ones described above wherein said alternating current adaptable plug allows for bidirectional power flow such that said one or more rechargeable batteries may also be used to supply power from said one or more rechargeable batteries into the building or device said current adaptable plug is plugged into. Another alternative is a system such as the one described above, further comprising a sensor measuring the health of one or more batteries attached to said vehicle, sensing when it is over top of a battery replacement juncture in an automated replacement facility and signaling to said docking station to release one or more said batteries into the battery replacement juncture, said one or more released batteries now becoming one or more collected batteries. Another alternative is a system, such as the ones described above, wherein said sensor further detects when a battery replacement juncture in said facility has placed a battery within the appropriate proximity of said docking station, and said docking station further comprising a tool to autonomously collect and secure said replacement battery, picking up said replacement battery and securing it such that said electric vehicle may use said replacement battery for power. Another alternative is a system, such as the ones described above, wherein said automated battery replacement facility further comprises one or more computing devices that processes data regarding the amount of power remaining in said collected batteries and calculating a return credit that may be deducted from the battery replacement fee. Another alternative is a system, such as the ones described above, wherein said electric vehicle is a semi-autonomous vehicle further comprising a guidance system capable of guiding said vehicle to one or more service locations, vehicle charging stations, battery replacement facilities or other vehicle, cart or battery servicing locations. Yet another alternative is a system, such as the ones described above wherein said automated battery replacement facility is operated entirely autonomously in conjunction with said electric vehicle, said electric vehicle comprising a computing system for locating the nearest facility for automated servicing of the battery or signaling to an automated replacement facility a notification that causes the battery to be removed for service and either serviced while attached to the asset or removed for servicing and replaced, said battery replacement fee and return credit being autonomously processed to the vehicle owner.

It is understood that the various embodiments are shown and described above to illustrate different possible features of the invention and the varying ways in which these features may be combined. Apart from combining the different features of the above embodiments in varying ways, other modifications are also considered to be within the scope of the invention.

The invention is not intended to be limited to the embodiments described above, but rather is intended to be limited only by the claims set out below. Thus, the invention encompasses all alternate embodiments that fall literally or equivalently within the scope of these claims.

Having thus described my invention, I claim:

1. An apparatus comprising:
a) one or more electromagnetic surface,
b) an object holder with a magnetic face resting on the electromagnetic surface with an opposite charge.

2. The apparatus described in claim 1 further comprising a magnetic field mechanism adjuster.
a) an adjustable timer,
b) a response mechanism that activates or deactivates the electromagnetic surface in response to the countdown of the timer,
c) an application interface to remotely control the timer,
d) one or more concentric surfaces with varying electromagnetic charges that may adjust the angle of any opposing magnetic object,
e) with a charging pad embedded in the electromagnetic surface,
f) an adjustable mechanism that allows a user to adjust the desired percent charged,
g) a response mechanism that activates or deactivates the electromagnetic surface in response to the percent the object is charged.

3. The apparatus described in claim 2 further comprising:
an apparatus interface to remotely adjust the desired percent charged prior to the electromagnetic surface activation and object levitation.

4. The apparatus described in claim 1 further comprising:
one or more motors which cause the electromagnetic surface to rotate such that any levitated object will spin in response.

5. The apparatus described in claim 4 further comprising:
a) a plurality of electromagnetic surfaces,
b) a field adjustment mechanism,
c) one or more motors, gears or pulleys.

6. A method, comprising:
measuring the health of one or more batteries attached to a powered asset;
signaling, by one or more computing devices the status of the health of the battery, location of the nearest facility or signaling to an automated replacement facility a notification that causes the battery to be removed for service and either serviced while attached to the asset or removed for servicing and replaced.

7. The method according to claim 6, wherein the battery is attached to a vehicle and removed by an automated drone when it is detected that the battery needs servicing.

8. The method according to claim 6, wherein the battery is embedded into a smart-shirt and maintenance includes an automated spray of perfume when perspiration is detected above a preset level.

9. The method according to claim 7, wherein the battery is attached to the base of the vehicle and a signal is transmitted between the vehicle and nearby battery maintenance facilities;
the vehicle then drives autonomously or semi-autonomously to one such maintenance facility if the battery is in need of maintenance or recharging; the battery is serviced, charged or replaced, and the vehicle receives a signal to leave the facility accordingly.

10. A system for charging or levitating an object, said system further comprising:
one or more batteries;
a docking station for one or more of said batteries;
an alternating current adapter plug for said docking station.

11. The system according to claim 10 further comprising one or more electromagnetic surfaces and one or more objects, wherein one or more of said magnetic surfaces is a charging pad, and one or more electromagnetic surfaces does not become active until a desired function is achieved, said function being:
a) a user defined charging time has passed, or
b) a user defined charging percent has been achieved.

12. The system of claim 11 wherein at least one of said objects is
a) a portable device,
b) an electric oral health device,
c) an electric razor,
d) an electric vehicle,
e) a cart,
or
f) a shoe comprising one or more sensors.

13. The system of claim 10 wherein said docking station is mounted to the underbelly of an electric vehicle, said electric vehicle using the one or more rechargeable batteries for electric power.

14. The system of claim 13 wherein said docking station further comprises an alternating current adaptable plug for recharging said one or more rechargeable batteries.

15. The system of claim 14 wherein said alternating current adaptable plug allows for bidirectional power flow such that said one or more rechargeable batteries may also be used to supply power from said one or more rechargeable batteries into the building or device said current adaptable plug is plugged into.

16. The system of claim 13 further comprising a sensor measuring the health of one or more batteries attached to said vehicle, sensing when it is over top of a battery replacement juncture in an automated replacement facility and signaling to said docking station to release one or more said batteries into the battery replacement juncture, said one or more released batteries now becoming one or more collected batteries.

17. The system of claim 16 wherein said sensor further detects when a battery replacement juncture in said facility has placed a battery within the appropriate proximity of said docking station, and said docking station further comprising a tool to autonomously collect and secure said replacement battery, picking up said replacement battery and securing it such that said electric vehicle may use said replacement battery for power.

18. The system of claim 17 wherein said automated battery replacement facility further comprises one or more computing devices that processes data regarding the amount of power remaining in said collected batteries and calculating a return credit that may be deducted from the battery replacement fee.

19. The system of claim 10 wherein said electric vehicle is a semi-autonomous vehicle further comprising a guidance system capable of guiding said vehicle to one or more service locations, vehicle charging stations, battery replacement facilities or other vehicle, cart or battery servicing locations.

20. The system of claim 18 wherein said automated battery replacement facility is operated entirely autonomously in conjunction with said electric vehicle, said electric vehicle comprising a computing system for locating the nearest facility for automated servicing of the battery or signaling to an automated replacement facility a notification that causes the battery to be removed for service and either serviced while attached to the asset or removed for servicing and replaced, said battery replacement fee and return credit being autonomously processed to the vehicle owner.
